(19) United States
(12) Patent Application Publication
(10) Pub. No.: US 2011/0313739 A1
(43) Pub. Date: Dec. 22, 2011

(54) HYBRID MODELS OF MULTI-COMPONENT VAPOR LIQUID SEPARATION EQUIPMENT

(75) Inventors: Vladimir Mahalec, Sudbury (CA); Yoel Sanchez, Hamilton (CA); Asaad Hashim, Al Khobar (SA)

(73) Assignee: McMASTER UNIVERSITY, Hamilton (CA)

(21) Appl. No.: 13/106,069

(22) Filed: May 12, 2011

Related U.S. Application Data
(60) Provisional application No. 61/334,384, filed on May 13, 2010.

(51) Int. Cl. G06G 7/58; G06F 17/10

(52) U.S. Cl. 703/2

(57) ABSTRACT

Four different forms of hybrid models of vapor-liquid separation equipment. These are: (i) hybrid models for monitoring the equipment operation based on the plant operating data, (ii) a predictive hybrid model which computes product properties if feed properties are known (iii) a predictive hybrid model which can compute product qualities from the flows entering or leaving the tower without having to know the feed properties, and (iv) a feed properties identification hybrid model.

### CROSS-REFERENCE TO RELATED APPLICATIONS

This application claims priority from co-pending provisional patent application having Ser. No. 61/334,384 filed on May 13, 2010, the entire disclosure of which is incorporated herein by reference.

### TECHNICAL FIELD

This invention relates to models of multi-component vapor liquid separation equipment and their use for monitoring and prediction of equipment performance.

### BACKGROUND OF THE INVENTION

Models of vapor liquid separation equipments are used to design or to monitor and optimize their operation in industrial plants such as refineries, chemicals, or similar plants. This invention enables modeling of multi-component vapor liquid separation equipment via hybrid models that have accuracy comparable to the rigorous tray to tray models while having much smaller number of equations than the rigorous tray to tray models. Hybrid models presented in this invention are suitable for monitoring of operation, optimization of operating conditions, production planning or production scheduling.

### SUMMARY OF THE INVENTION

Four different forms of hybrid models of vapor-liquid separation equipments are presented in this invention: (i) Hybrid Models for Monitoring the Operation based on the plant operating data, (ii) Predictive Hybrid Model “Feed Known” which computes product properties if feed properties are known (iii) Predictive Hybrid Model “Feed Unknown” which can compute product qualities from the flows entering or leaving the tower, without having to know the feed properties, and (iv) Feed Properties Identification Hybrid Model.

Mode 1—Hybrid Model for Monitoring the Operation in this invention can be of three types:

Type 1 Monitoring Hybrid Model in this invention consists an empirical model (e.g. PLS model) that employs selected tray temperatures and feed qualities (e.g. density, specific gravity) that indirectly relates to the feed composition to predict product quality (e.g. points on the distillation curve or % of a specific component in a given product).

Type 2 and Type 3 Monitoring Hybrid Model in this invention is used when there are not enough available tray temperature measurements to be able to develop a model of Type 1. Both of these types use the operating data to predict product properties and consist of:
1. Empirical equations that predict product properties based on the equipment internal reflux on selected trays, selected tray temperatures, feed quality (e.g. density) that indirectly relates to the feed composition, and (if applicable) additional operating variables that impact separation between products (e.g. stripping steam flows). Multi-component product properties are described either by composition (% of component) or by its distillation curve; the latter can be a True Boiling Point distillation curve or some other type of a distillation curve.
2. Mass and energy balances for the trays as required for computing the internal reflux on the trays.
3. Equations to compute liquid and vapor enthalpies at the trays.
4. Equations to compute enthalpy of all streams entering or leaving the distillation tower.

Type 2 Model predicts directly TBP points on the product distillation curves. Type 3 Model predicts a straight line that passes through the middle section of the product TBP curve (e.g. through TBP 30% and TBP 70%) and then predicts differences between the product TBP points and that straight line. Addition of these difference to the straight line calculates the actual points on the distillation curve.

Mode 2—Predictive Hybrid Model “Feed Known” in this invention uses feed TBP cut point temperatures and optionally the internal tower reflux on selected trays to estimate the product properties.

Mode 3—Predictive Hybrid Model “Feed Unknown” in this invention is used to predict product properties when tray temperatures are not known in advance and when feed properties are not known. This model predicts product properties by the following iterative procedure: (i) assume tray temperatures, (ii) compute product properties from Type 2 Monitoring Hybrid Model, (iii) compute tray temperatures from Type 1 Monitoring Hybrid Model, (iv) check if assumed tray temperatures are the same as computed tray temperatures; if not, go to (i), otherwise stop.

Mode 4—Feed Properties Identification Hybrid Model consists of empirical equations that predict points on the feed distillation curve from the tray temperatures and from the internal reflux on selected trays.

Empirical parts of the hybrid models are either linear Partial Least Squares models or nonlinear models.

Enthalpies of vapor and liquid streams on each tray are computed as a temperature dependent and pressure dependent linear approximations around the enthalpy at the base conditions on each tray, with adjustment for feed density.

### BRIEF DESCRIPTIONS OF THE DRAWINGS

FIG. 1 illustrates a Distillation tower

FIG. 2 illustrates a Sample Feed and Products TBP curves.

FIG. 3 illustrates a Distillation Unit Feed and Products TBP curve.

FIG. 4 illustrates Envelopes for Mass and Energy Balances.

FIG. 5 illustrates Cp vs. MW for a hydrocarbon mixture

FIG. 6 illustrates Molecular weight ratios

FIG. 7 illustrates Absorber Unit mass and energy balances

FIG. 8 illustrates Feed vapor fraction vs Temperature

FIG. 9 illustrates Feed Enthalpy vs. Temperature

FIG. 10 illustrates Stripper unit mass and energy balances

FIG. 11 illustrates Two crude oil feeds

FIG. 12 illustrates Distillation Column Model test, Liquid Distillate Product.

FIG. 13 illustrates Distillation Column Model test, Vapor Distillate Product.

FIG. 14 illustrates Distillation Column Model test, Bottom Product.

FIG. 15 illustrates Flash Model test, Top Product.

FIG. 16 illustrates Flash Model test, Bottom Product.

FIG. 17 illustrates Absorber Model test, Liquid Distillate Product.

FIG. 18 illustrates Absorber Model test, Vapor Distillate Product.

FIG. 19 illustrates Absorber Model test, Bottom Product.

FIG. 20 illustrates Stripper Model test, Top Product.

FIG. 21 illustrates Stripper Model test, Bottom Product.

FIG. 22 illustrates Distillation column Optimization Problem results

FIG. 23 illustrates Cut point definition. Source: Watkins (1979)

FIG. 24 illustrates Distillation Process Diagram. Source: Sanchez (2009)

FIG. 25 illustrates Predicted variables definition.

FIG. 26 illustrates Flash Unit, Volume based model variables.

FIG. 27 illustrates PLS components for Flash Unit model (Volume based).

FIG. 28 illustrates VIP plot for Flash Unit model (Volume based).

FIG. 29 illustrates Flash Model test (volume based), Top Product.

FIG. 30 illustrates illustrates Flash Model test (volume based), Bottom Product.

FIG. 31 illustrates Flash Unit, Molar based model variables.

FIG. 32 illustrates PLS components for Flash Unit model (Molar based).

FIG. 33 illustrates VIP plot for Flash Unit model (Molar based).

FIG. 34 illustrates Flash Model test (molar based), Top Product.

FIG. 35 illustrates Flash Model test (molar based), Bottom Product.

FIG. 36 illustrates Distillation Unit, volume based model variables.

FIG. 37 illustrates PLS components for Distillation Unit model (volume based).

FIG. 38 illustrates VIP plot for Distillation Unit model (volume based).

FIG. 39 illustrates Distillation Model test (volume based), Top Product.

FIG. 40 illustrates Distillation Model test (volume based), Bottom Product.

FIG. 41 illustrates Distillation Unit, molar based model variables.

FIG. 42 illustrates PLS components for Distillation Unit model (molar based).

FIG. 43 illustrates VIP plot for Distillation Unit model (volume based).

FIG. 44 illustrates Distillation Model test (molar based), Top Product.

FIG. 45 illustrates Distillation Model test (molar based), Bottom Product.

FIG. 46 illustrates Stripper Unit, volume based model variables.

FIG. 47 illustrates PLS components for Stripper Unit model (volume based).

FIG. 48 illustrates VIP plot for Stripper Unit model (volume based).

FIG. 49 illustrates Stripper Model test (volume based), Top Product.

FIG. 50 illustrates Stripper Model test (volume based), Bottom Product.

FIG. 51 illustrates Stripper Unit, molar based model variables.

FIG. 52 illustrates PLS components for Stripper Unit model (molar based).

FIG. 53 illustrates VIP plot for Stripper Unit model (molar based).

FIG. 54 illustrates Stripper Model test (molar based), Top Product.

FIG. 55 illustrates Stripper Model test (molar based), Bottom Product.

FIG. 56 illustrates Absorber Unit, volume based model variables.

FIG. 57 illustrates PLS components for Absorber Unit model (volume based).

FIG. 58 illustrates VIP plot for Absorber Unit model (volume based).

FIG. 59 illustrates Absorber Model test (volume based), Top Product.

FIG. 60 illustrates Absorber Model test (volume based), Bottom Product.

FIG. 61 illustrates Absorber Unit, molar based model variables.

FIG. 62 illustrates PLS components for Absorber Unit model (molar based).

FIG. 63 illustrates VIP plot for Absorber Unit model (volume based).

FIG. 65 illustrates Hybrid models summary (molar based).

FIG. 66 illustrates Crude Distillation Unit (CDU)

FIG. 67 illustrates Mode 1, Type 1 Monitoring Model—example of PLS components

FIG. 68 illustrates Mode 1, Type 1 Model: Comparison of Heavy Naphtha TBP between the hybrid model and ASPENPLUS model

FIG. 69 illustrates Mode 1, Type 1 Model: Comparison of Front End of Kerosene TBP between the hybrid model and ASPENPLUS model

FIG. 70 illustrates Mode 1, Type 1 Model: Comparison of Back End of Kerosene TBP between the hybrid model and ASPENPLUS model

FIG. 71 illustrates Mode 1, Type 1 Model: Comparison of Front End of Diesel TBP between the hybrid model and ASPENPLUS model

FIG. 72 illustrates Mode 1, Type 1 Model: PLS Components for the hybrid model that uses tray temperatures, internal refluxes, and feed specific gravity

FIG. 73 illustrates Mode 1, Type 1 Model: Sample of prediction errors for key product properties

FIG. 74 illustrates Mode 1, Type 2 Model at Fixed Feed Properties (i.e. constant specific gravity)—Prediction of Product Properties—RMSE for three distinct crudes

FIG. 75 illustrates Mode 1, Type2 Model: Dependence of Product Property PLS coefficients on specific gravity of the crude feed; Example of Distillate TBP95% coefficients

FIG. 76 illustrates Mode 1, Type 2 Model: Dependence of Product Property PLS coefficients on specific gravity of the crude feed; Example of Kerosene TBP95% coefficients

FIG. 77 illustrates Mode 1, Type 3 Model: Monitoring Hybrid Model Predicts Differences Between Product TBP Points and the Straight Line through the Middle Part of the Product Distillation Curve.

FIG. 78 illustrates Mode 1, Type 3 Model: Accuracy of Prediction of the Straight Lines through (TBP30%, TBP70%) points of the Distillation Curves of the Products

FIG. 79 illustrates Mode 1, Type 3 Model: Prediction of Product TBP Points Deviation from (TBP30%, TBP70%) Line; Example of Diesel TBP5% Point

FIG. 80 illustrates Mode 2 Model Example: Comparison of Back End of HNaphtha and Front End of Kerosene TBP prediction between hybrid model and ASPEN PLUS model

FIG. 81 illustrates 2 Model Example: Comparison of Back End of Kerosene and Front End of Diesel TBP between hybrid model and ASPENPLUS

FIG. 82 illustrates Mode 2 Model Example: Comparison of Back End of Diesel and Front End of AGO TBP between hybrid model and ASPENPLUS

FIG. 83 illustrates Mode 4 Model Example: Comparison of Predicted Feed TBP points by the Hybrid Model and the Actual feed TBP points in the Rigorous AspenPlus Model

FIG. 84 illustrates Summary of Hybrid Models described in this invention

### DETAILED DESCRIPTION

The first part of Detailed Description will describe hybrid models for flash, simple distillation, absorption, and stripping towers. The second part of Detailed Description will describe hybrid models for complex distillation towers, such as atmospheric crude distillation towers or FCC main fractionators.

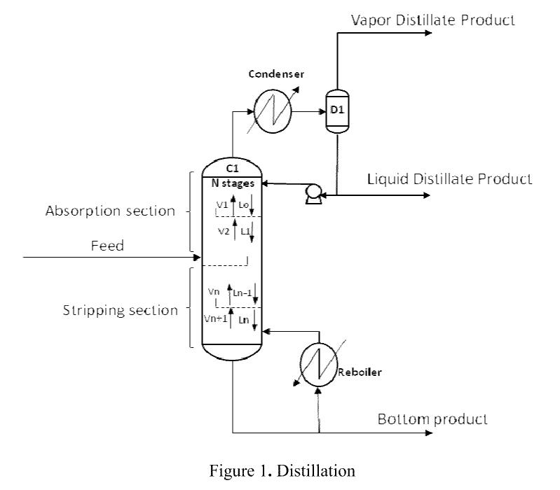

In a simple distillation process, as shown in FIG. 1 with partial condenser, components from a feed stream are separated generating three products: vapor distillate, liquid distillate and bottom. In general, a distillation column can be divided in two sections: the absorption section and the stripping section. In the absorption section trace components are removed from gas streams. In the stripping section trace components are removed from the liquid in a more concentrated form.

Strippers can be defined as a distillation column with only stripping section. Similarly, absorbers are distillation columns with only absorption section.

Flash vaporization, or equilibrium distillation as it is sometimes called, is a single-stage operation wherein a liquid mixture is partially vaporized, the vapor allowed to come to equilibrium with the residual liquid, and the resulting vapor and liquid phases are separated”.

Distillation, stripping, absorption and flash vaporization are all techniques used to separate binary and multi-component mixtures of liquids and vapors.

Hybrid model of vapor liquid separation equipment consists of:
Material and energy balance equations for selected trays in the equipment.
Empirical model to relate intensive operating variables (internal reflux ratios, tray temperatures, stripping steam flows), volatility related properties of the feed and volatility related properties of the products (or if volatility related properties of the feed are not known, then using feed density as a surrogate).

We have developed empirical models using Partial Least Squares.

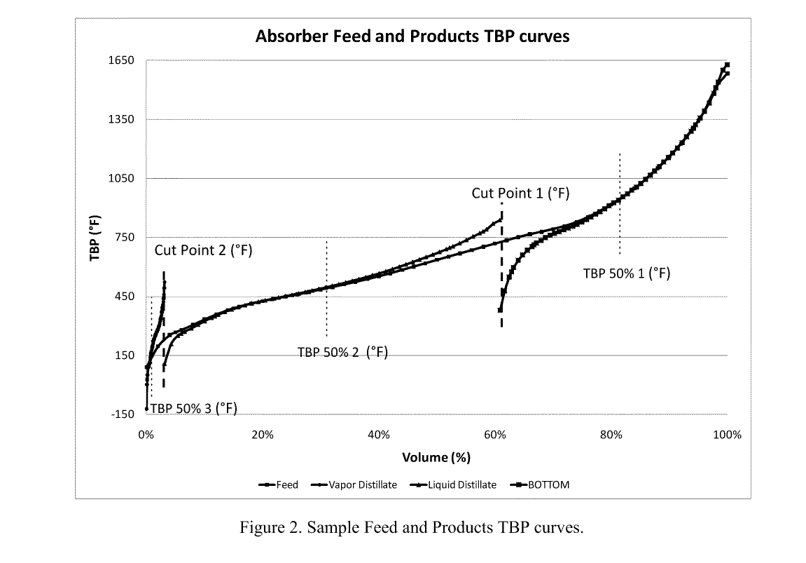

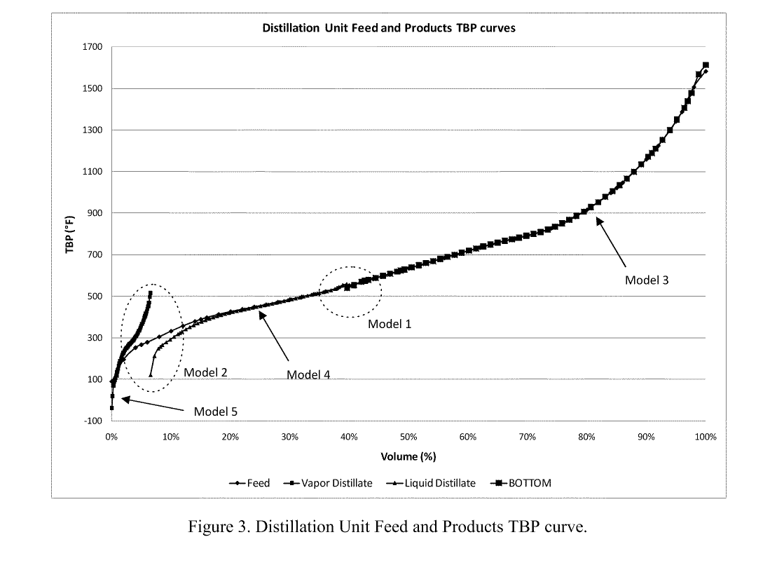

If material processed in a distillation tower is a petroleum mixture (e.g. a crude oil or the resulting products), then feed and products can be characterized by their boiling point curves. The initial boiling point is the temperature at which they start to boil, and the final boiling point is the temperature at which they have boiled completely. Hence, a curve of temperature vs. the volume percent of boiled mixture is known as boiling point curve. In FIG. 2 an example of a True Boiling Point (TBP) curve for the feed and products is presented.

The quality of the products is affected by several process variables. Since the goal of this work is to build simplified models to estimate products quality, only few variables will be considered. These “key variables” are:
If the feed distillation curve is known: cut-points temperatures (temperatures corresponding to the start and the end of the specific product on the feed TBP curve).
If the feed distillation curve is not known: feed density (as a surrogate representation of feed properties).
Selected points on the products TBP curve; this corresponds to pseudocomponents which will be used to calculate relative volatilities. TBP curve points corresponding to a “x” LV % distilled (e.g. 50%) will be called “product TBP x %” (e.g. naphtha TBP 50%).
Relative volatility,
Internal reflux ratio, and
Number of stages.

Cut-points can be determined by knowing the feed TBP curve and, feed and products volumetric flow rates, as shown in FIG. 2.

“Cut point 1” is equal to the feed TBP point at

$$( \frac{feed - bottom}{feed} \times 100 ) \% .$$

“Cut point 2” is equal to the feed TBP point at

$$( \frac{feed - bottom - liquid distillate}{feed} \times 100 ) \% .$$

Following the same idea from cut points, products TBP 50% are the point in TBP curves where 50% of each product has boiled. Again, considering the feed TBP curve and feed and products volumetric flow rates, then:
Product 1 (bottom) “TBP 50% 1” is equal to the feed TBP point at

$$( \frac{feed - bottom / 2}{feed} \times 100 ) \% .$$

“TBP 50% 2” (corresponding to the liquid distillate product) is equal to the feed TBP point at

$$( \frac{feed - bottom - liquid distillate / 2}{feed} \times 100 ) \% .$$

“TBP 50% 3” (corresponding to the vapor distillate product) is equal to the feed TBP curve at

$$( \frac{feed \text{-} \text{bottom} \text{-} liquid distillate \text{-} vapor distillate / 2}{feed} \times 100 ) \% ,$$

Relative volatility is expressed as the ratio of vapor pressure of the more volatile to the less volatile in the liquid mixture. The greater the value of α, the easier will be the desired separation. Relative volatility can be calculated between any two components in a mixture, binary or multi-component. One of the substances is chosen as the reference to which the other component is compared.

Then relative volatility of component 1 with respect to component 2 is expressed as:

$${α}_{1 , 2} = \frac{{p}_{1} {x}_{2}}{{p}_{2} {x}_{1}} = \frac{{y}_{1} {x}_{2}}{{y}_{2} {x}_{2}} = \frac{{k}_{1}}{{k}_{2}} \qquad ( 1.1 )$$

where

1,2, etc. are the components identification

p=partial pressure of component

x=liquid mol fraction of a component

y=vapor mol fraction of a component

Crude oil feedstocks are modeled as a mixture of pseudocomponents, where each pseudocomponent is associated to a boiling point temperature. Hence, relative volatilities are calculated with respect to key pseudocomponents.

Following the cut points and products TBP 50% indicated in the figure above, the pseudocomponents are defined as:

1: pseudocomponent at “TBP 50% 3”.

2: pseudocomponent at “cut point 2”.

3: pseudocomponent at “TBP 50% 2”.

4: pseudocomponent at “cut point 1”.

5: pseudocomponent at “TBP 50% 1”.

Then the relative volatilities are calculated according to the following expressions:

$${α}_{1 , 2} = \frac{{k}_{1}}{{k}_{2}} , {α}_{2 , 3} = \frac{{k}_{2}}{{k}_{3}} , {α}_{3 , 4} = \frac{{k}_{3}}{{k}_{4}} , {α}_{4 , 5} = \frac{{k}_{4}}{{k}_{5}} \qquad ( 1.2 )$$

The linear model obtained is:

TBPⱼₗ=f(irrₖ, α, TBP_{Feed}, cut points, TBP 50%ⱼ,n) (1.3)

where:
j=product stream (vapor distillate, liquid distillate, bottom)
l=percent of volume
k=top tray, bottom tray
irr=internal reflux ratio
α=relative volatility
TBP_{Feed}=Feed TBP curve
n=number of stages

Mass and energy balances are performed in order to calculate the process internal variables: liquid flowrate at stage i, and vapor flowrate at stage i+1. This allows determining the internal reflux ratio irr, according to the equation:

$${irr}_{i} = \frac{{L}_{i}}{{V}_{i + 1}} ( molar ) \qquad ( 1.4 )$$

Notice that the traditional way to calculate internal reflux is

$${irr}_{i} = \frac{{L}_{i}}{{V}_{i}} ,$$

but in this investigation was found that for the cases studied internal reflux calculated with the equation 1.4 has more influence in the quality variables than the traditional reflux ratio.

Then, the liquid flow and vapor flow are function of reboiler duty, condenser duty, and feed and products flowrates.

Lᵢ=f(Q_{Cond}, Q_{Reb}, flowrates) (1.5)

Vᵢ=f(Q_{Cond}, Q_{Reb}, flowrates) (1.6)

Enthalpies of liquid and vapor are calculated via the following approximation:

h=h⁰+cp_{L}x(T−T⁰) (1.7)

H=H⁰+cp_{V}x(T−T⁰) (1.8)

where superscript “0” denotes base operating conditions.

To model a distillation tower in FIG. 1, separate PLS models (Model 1 and Model 2) are created for separation between each two adjacent products, while a third model (Model 3) is created to predict those sections of the product distillation curves that are not contaminated by carry-over from adjacent product.
Model 1: Y variables=Bottom product TBP (0-15%) and Liquid Distillate product TBP (85-100%)
Model 2: Y variables=Liquid Distillate product TBP (5-15%) and Vapor Distillate product TBP (85-100%)
Model 3: Y variables=Bottom product TBP (20-100%), Liquid Distillate product TBP (20-80%), and Vapor Distillate product TBP (0-80%).

The X's variables required to build the model are: relative volatility (alpha), feed TBP curve, cut points, TBP 50% of products, number of stages, and internal reflux ratio for the top and bottom tray. In order to simplify the models a new parameter is included in this section, internal reflux average, defined as:

irr_{avg}=\sqrt{irr_{Top}*irr_{Bottom}} (1.9)

Fidelity of all models is very high:

Model 1 R²=0.98 and Q²=0.97

Model 2 R²=0.96 and Q²=0.95

Model 3 R²=0.99 and Q²=0.98

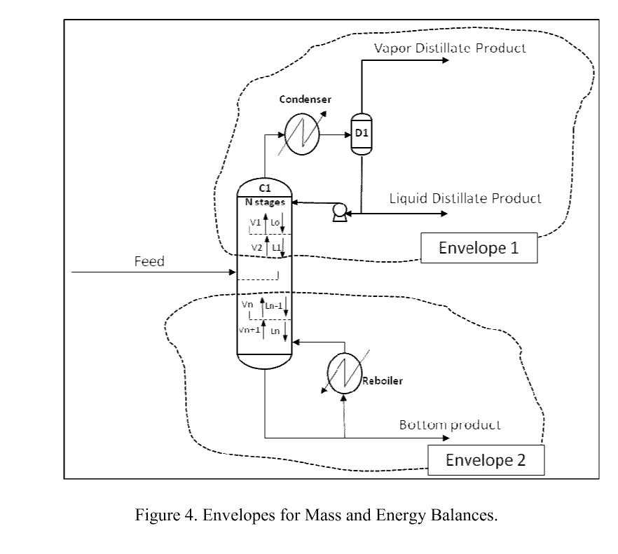

Mass and energy balances are performed to calculate the parameters L₁, V₂, Lₙ₋₁, Vₙ. Envelopes for balances in the distillation unit are defined in FIG. 4.

Envelope 1

$${irr}_{1} = \frac{{L}_{1} * M {W}_{V 2}}{{V}_{2} * M {W}_{L 1}} \qquad ( 1.10 )$$

V₂=Vapor Distillate+Liquid Distillate+L₁ (1.11)

H_{V2}V₂=H_{VD}Vapor Distillate+h_{LD}Liquid Distillate+h_{L1}L₁+Q_{cond} (1.12)

Envelope 2

$$\begin{matrix}{irr}_{n - 1} = \frac{{L}_{n - 1} * M {W}_{Vn}}{{V}_{n} * M {W}_{L n - 1}} & ( 1.13 ) \\ {L}_{n - 1} = Bottom + {V}_{n} & ( 1.14 ) \\ {h}_{L n - 1} {L}_{n - 1} + {Q}_{reb} = {h}_{B} Bottom + {H}_{Vn} {V}_{n} & ( 1.15 )\end{matrix}$$

where:

irr=molar based internal reflux ratio

L, V [lb/hr]=Vapor distillate, liquid distillate, bottom:

h,H [BTU/lb]=liquid and vapour enthalpies

Q [BTU/hr]=heat duty

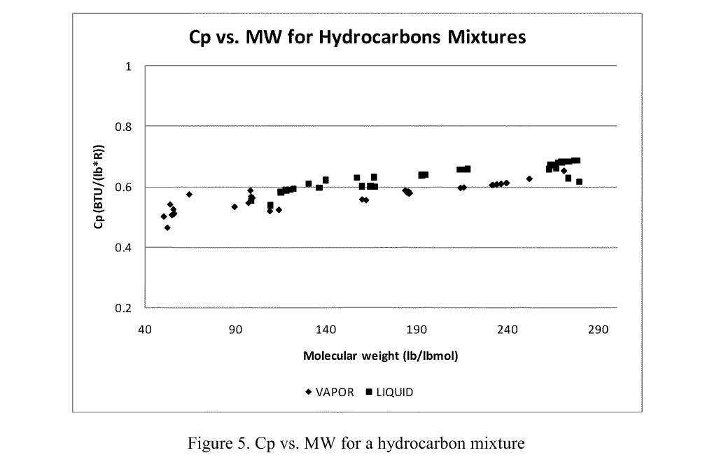

Since changes in tower operation do not alter drastically composition on a given tray, the molecular weight of the mixture on a tray does not vary significantly. FIG. 5 shows that heat capacities of vapor and liquid phases do not vary much with changes in molecular weight. Hence, the heat capacities on a given tray can be assumed to be constant.

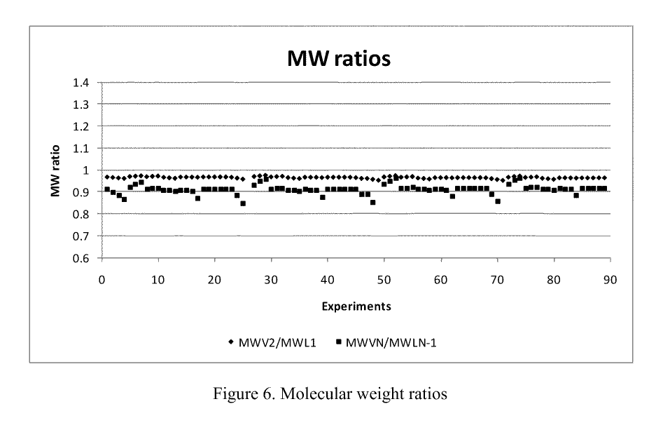

Calculation of internal reflux ratio requires ratio of molecular weights of the vapor and the liquid phase. FIG. 6 shows that these ratios over a wide range of experiments. It can be assumed that these ratios are constant.

The model of a flash unit is simpler, since there are no internal trays. Hence, the internal reflux ratio is given by:

$$irr = \frac{Bottom}{Top} \qquad ( 1.16 )$$

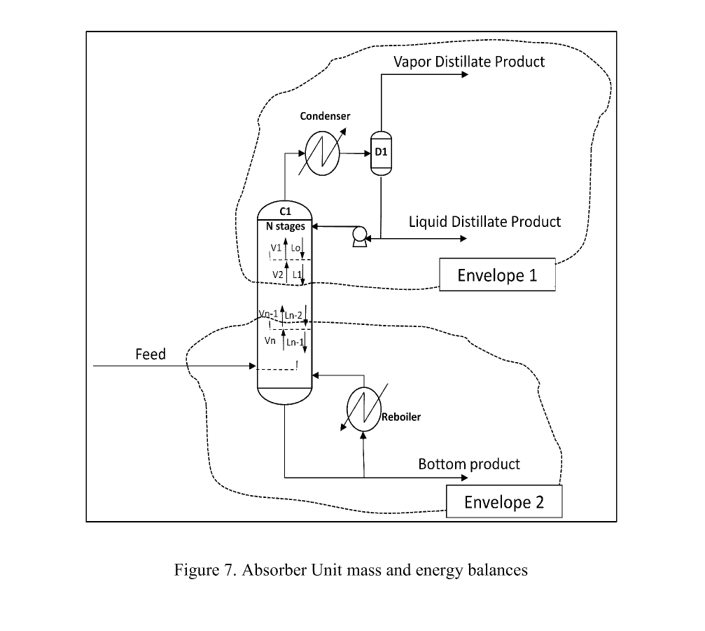

To model and absorber unit, mass and energy balances are performed to calculate the parameter L₁, V₂, Lₙ₋₂, Vₙ₋₁. Envelopes for balances in the absorber unit are defined in FIG. 7.

Envelope 1

$${irr}_{1} = \frac{{L}_{1} * M {W}_{V 2}}{{V}_{2} * M {W}_{L 1}} \qquad ( 1.17 )$$

V₂=Vapor Distillate+Liquid Distillate+L₁ (1.18)

H_{V2}V₂=H_{VD}Vapor Distillate+h_{LD}Liquid Distillate+h_{L1}L₁+Q_{cond} (1.19)

Envelope 2

$$\begin{matrix}{irr}_{n - 2} = \frac{{L}_{n - 2} * M {W}_{Vn}}{{V}_{n - 1} * M {W}_{L n - 1}} & ( 1.20 ) \\ Feed + {L}_{n - 2} = Bottom + {V}_{n - 1} & ( 1.21 ) \\ {H}_{Feed} Feed + {h}_{{L}_{n - 2}} {L}_{n - 2} = {h}_{Bottom} Bottom + {H}_{{V}_{n - 1}} {V}_{n - 1} & ( 1.22 )\end{matrix}$$

where

H_{Feed}Feed=Feed_{vaporfeed}φ+Feedh_{liquidfeed}(1−φ) (1.23)

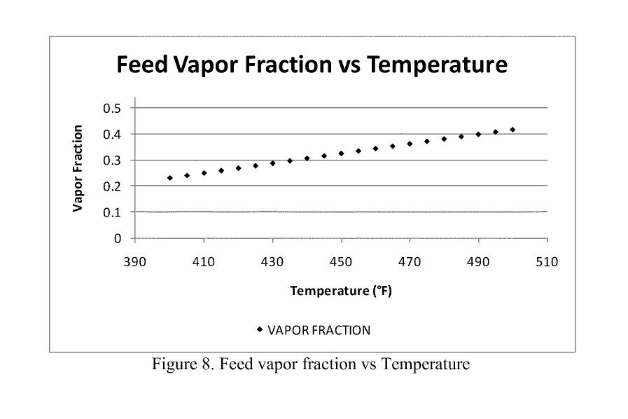

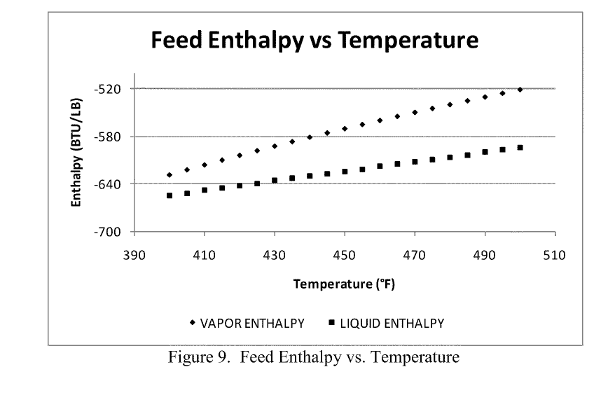

Parameters H_{vaporfeed}, h_{liquidfeed} and vapor fraction (φ) can be estimated from the feed temperature since they are related linearly. Examples for a sample feedstock are shown in FIGS. 8 and 9.

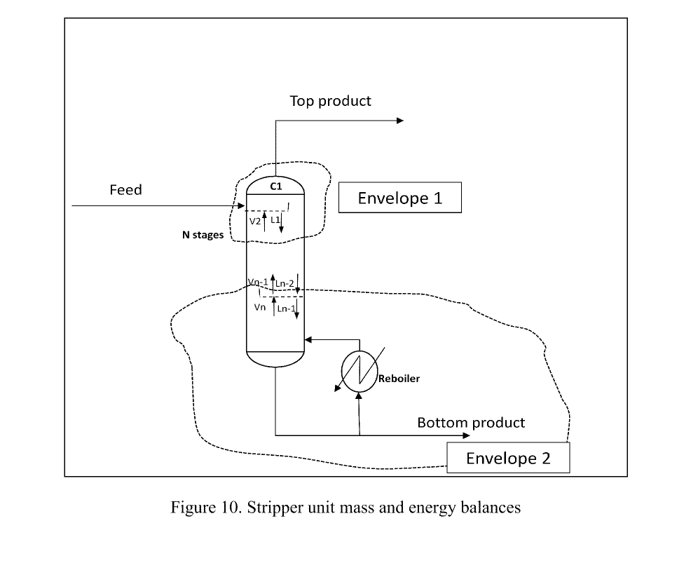

To model a stripper unit, mass and energy balances are performed to calculate the parameter L₁, V₂, Lₙ₋₁, Vₙ. Envelopes for balances in the absorber unit are defined in FIG. 10.

Envelope 1

$$\begin{matrix}{irr}_{1} = \frac{{L}_{1} * M {W}_{V 2}}{{V}_{2} * M {W}_{L 1}} & ( 1.24 ) \\ {V}_{2} + Feed = Top + {L}_{1} & ( 1.25 ) \\ {H}_{V 2} {V}_{2} + {H}_{Feed} Feed = {H}_{Top} Top + {h}_{L 1} {L}_{1} & ( 1.26 )\end{matrix}$$

where

H_{Feed}Feed is calculated as is shown in the absorber unit

Envelope 2

$$\begin{matrix}{irr}_{n - 1} = \frac{{L}_{n - 1} * M {W}_{Vn}}{{V}_{n} * M {W}_{L n - 1}} & ( 1.27 ) \\ {L}_{n - 1} = Bottom + {V}_{n} & ( 1.28 ) \\ {h}_{L n - 1} {L}_{n - 1} + {Q}_{reb} = {h}_{B} Bottom + {H}_{Vn} {V}_{n} & ( 1.29 )\end{matrix}$$

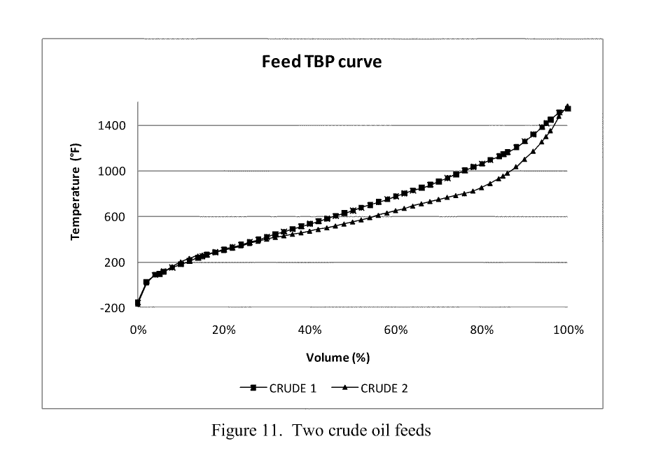

Models described above were developed using specific crudes (Crude 1 and crude 2 in FIG. 11). In order to test the model performance, feed composition was changed to 60% crude 1 and 40% crude 2. In addition, the operating conditions were perturbed.

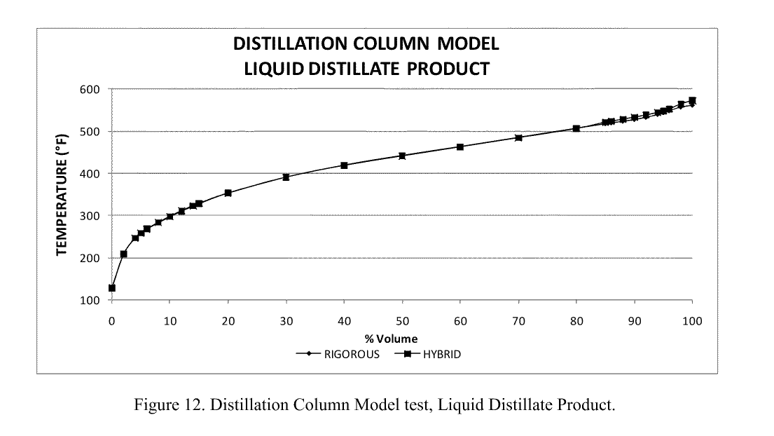

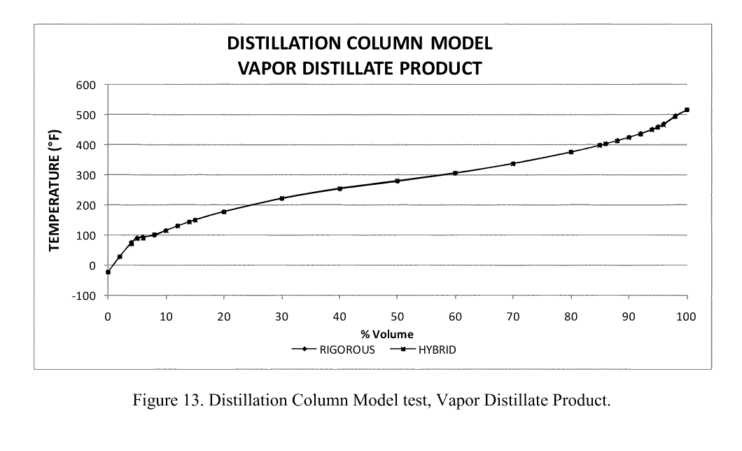

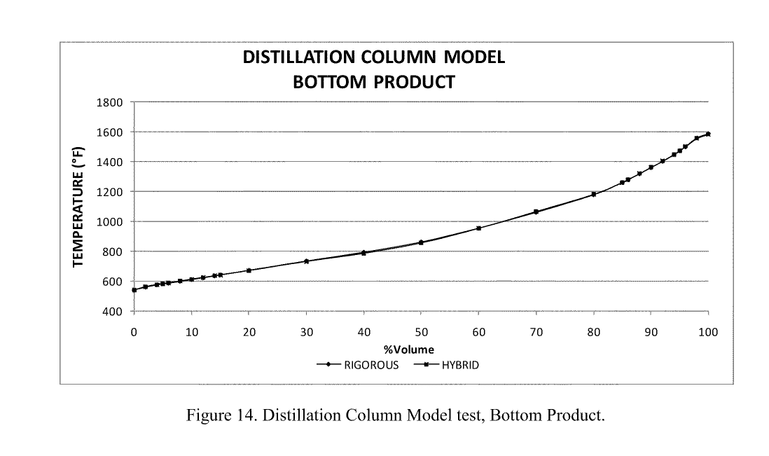

Prediction of product true boiling point (TBP) curves was compared to AspenPlus rigorous tray to tray model calculations. FIGS. 12, 13, and 14 show that predictions from the rigorous model and predictions from the hybrid model are almost identical.

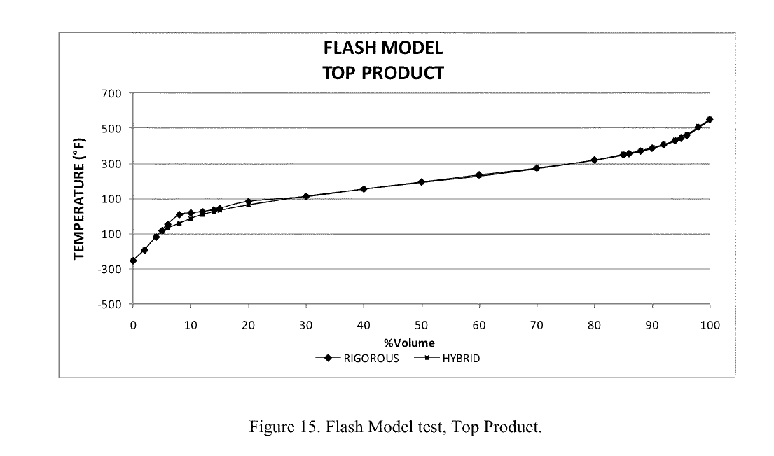

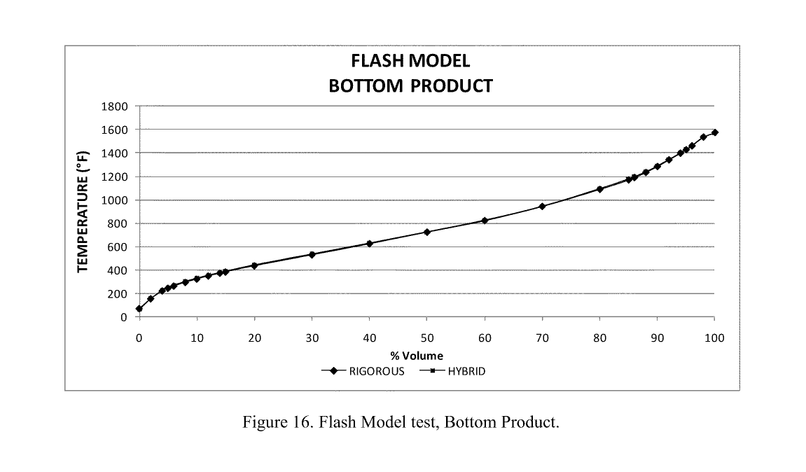

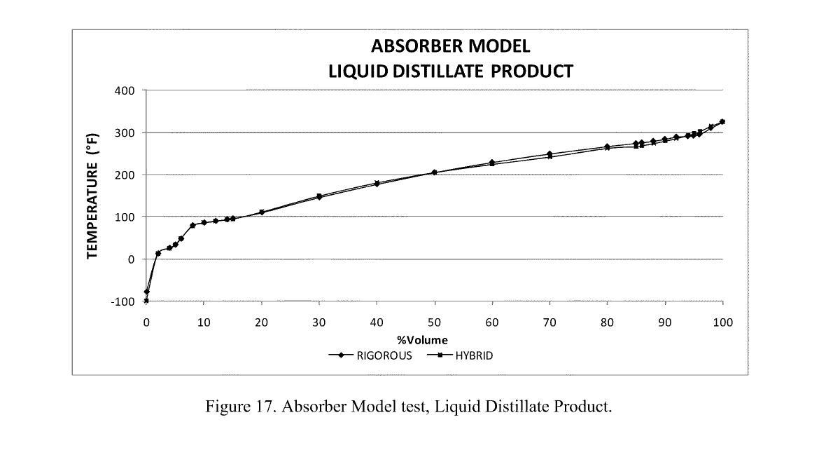

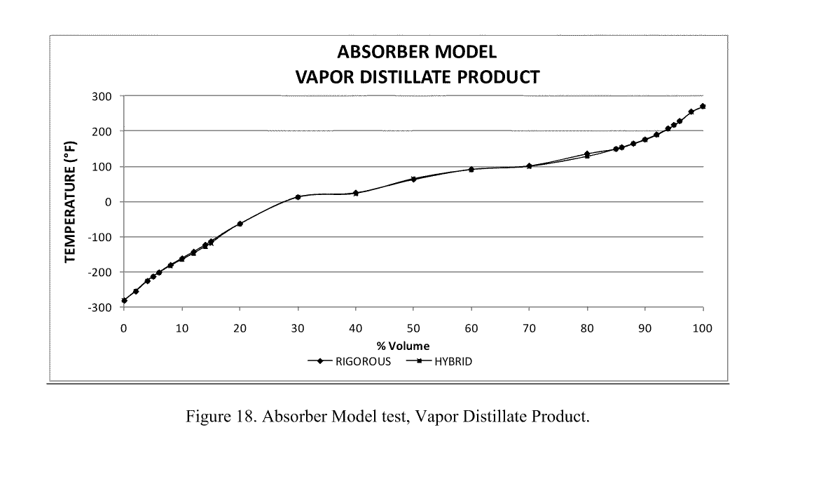

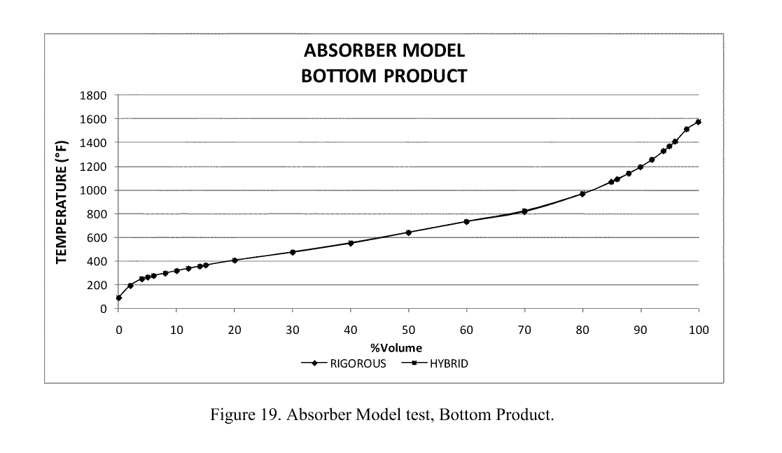

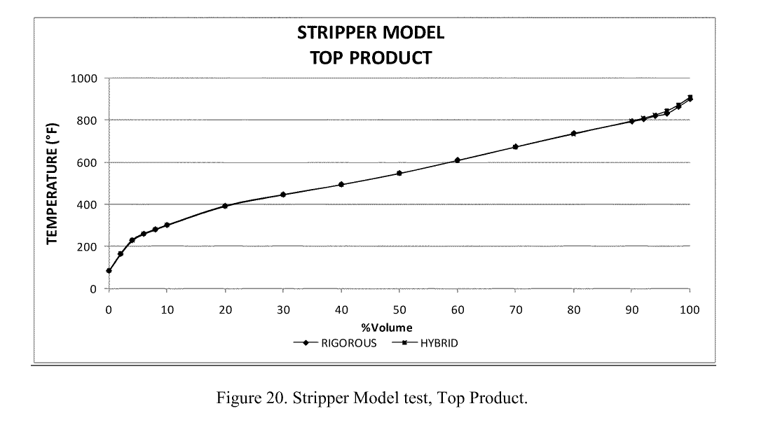

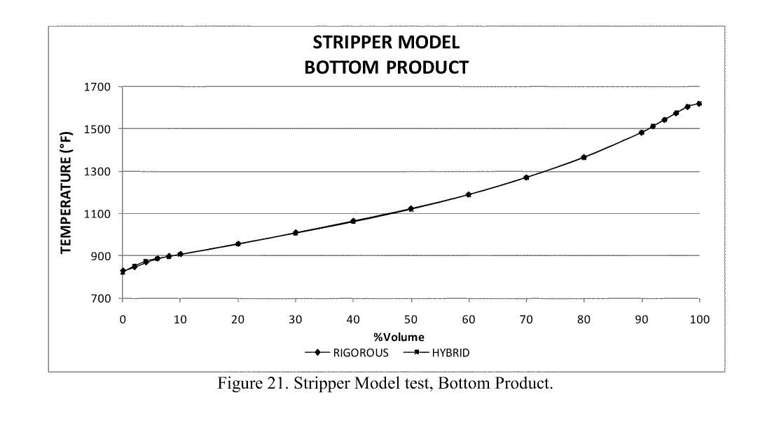

The same methodology described above was used for the flash, absorber and stripper separation units model's. FIGS. 15 to 21 present comparison between each product TBP curve predicted by the hybrid model against the TBP curve predicted by the rigorous model, for each separation unit.

According to all the figures presented in this section, it can be stated that the hybrid model has excellent prediction powers for estimation of products quality purpose.

To illustrate the accuracy of the hybrid model, the following optimization problem will be solved: Minimize the energy consumption and meet the quality targets of Liquid Distillate TBP 95%=545° F., and Bottom TBP 5%=580° F. The optimization problem is:

### Minimize: Qreb+Qcond

Inequality constraints:

Liquid Distillate TBP 95%≦545° F.

Bottom TBP 5%≧580° F.

Equality constraint

$${h}_{feed} Feed + {Q}_{reb} = {H}_{VD} Vapor Distillate + {h}_{LD} Liquid Distillate + {h}_{Bottom} Bottom + {Q}_{cond}$$

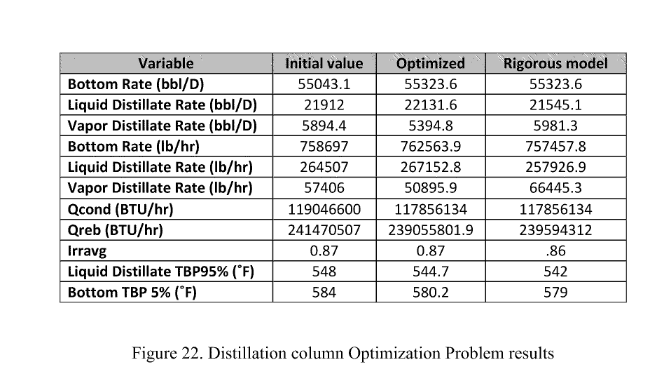

The optimization problem was solved using “fmincon” function of Matlab, using as free variables bottom rate, liquid distillate rate, Qcond and Qreb. The results are reported in FIG. 22.

Results from the hybrid model optimization were entered into a rigorous (AspenPlus) model of the same distillation tower. Excellent agreement between AspenPlus rigorous model and the hybrid model was obtained as seen in FIG. 22.

Above separation equipment models have been presented in the form that uses molar internal reflux. We have also developed hybrid models of the same structure, but have used internal reflux calculated as a ratio of mass flows. The results from mass-based internal reflux hybrid models have the same accuracy as the results from the molar based internal reflux hybrid models.

We have described how to construct a hybrid model with predicts directly the true boiling point (TBP) distillation curves of the products. Our experiments have shown that such direct prediction does not account well for the effect of number of stages. In order to account for the number of stages, one needs to predict difference between the TBP curve of a product and the TBP curve for that cut of the feed which corresponds to the product. Construction of such hybrid models is explained in this section

The key variables are:

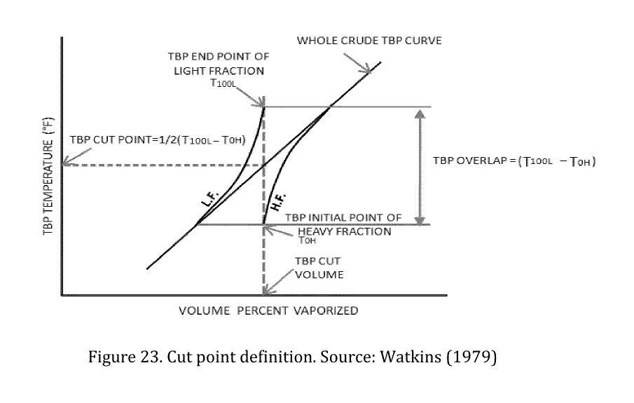

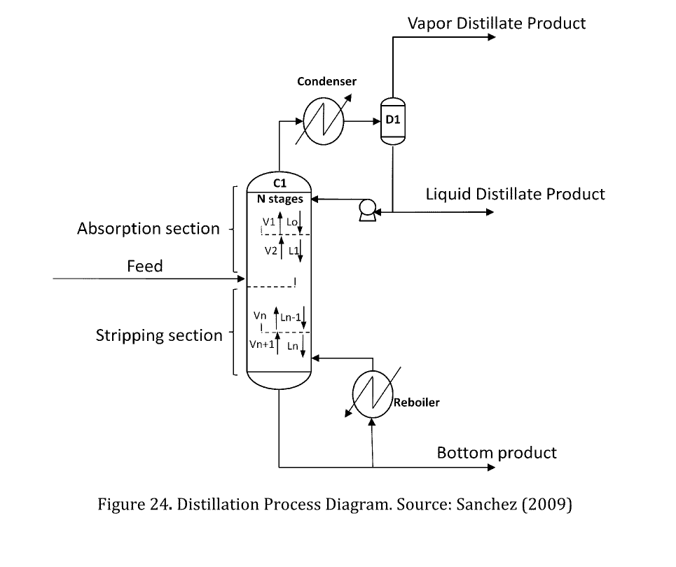

1. Temperature cut points: This key variable remains the same as it was defined in previous section, and it was described by many authors previously, e.g. Watkins (1979). The temperature cut point is the middle point of the TBP overlapping temperatures (T_{CP}=½×(T_{100L}−T_{0H}), where T_{100L} is the end point of the light fraction (LF) TBP curve, and T_{0H} is the initial point of the heavy fraction (HF) TBP curve. The concept of the temperature cut point is shown in FIG. 23.
2. Internal reflux ratio is defined as:

$${irr}_{i} = \frac{{L}_{i}}{{V}_{i}} ( molar ) ,$$

where Li represents the internal liquid flow in a specific stage and Vi is the internal vapour flow in a specific stage. In FIG. 24 is shown the definitions of liquid and vapour flows in the case of a distillation column.
3. Relative volatility indicates the level of difficulty of separation between two components in a mixture. When working with crude separation units the term pseudocomponent is used instead of single components. In this work, relative volatility is defined as the ratio of K values for predicted pseudocomponent corresponding to the target property to the K value of the cut point pseudo component. In other words, if for instance T₉₀ is the predicted variable, then the calculated relative volatility is defined as

$${α}_{90 , 100} = \frac{{k}_{90}}{{k}_{100}} .$$

Since T₉₀, the pseudocomponent located at 90% of the product TBP curve is not known in advance, an iterative procedure has to be performed using as initial value the pseudocomponent at base conditions.
4. Number of stages (theoretical trays).

Predicted Variables:

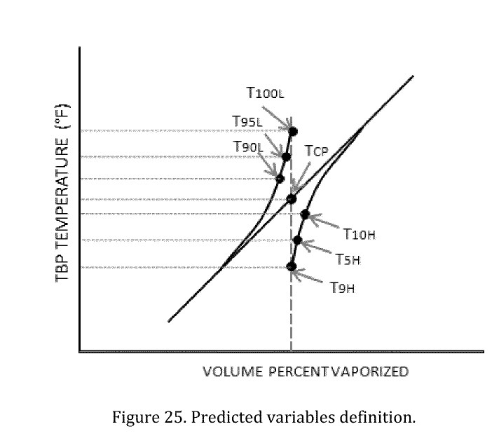

In the previous approach the predicted variables were defined in the model as the absolute values of the products TBP curve. Instead, in this part of our work is considered a relative value of the TBP curve that involves the cut point. For this work the predicted variables considered are: T_{90L}, T_{95L}, T_{100L}, T_{0H}, T_{5H}, T_{10H}, which basically define the quality of both products. In FIG. 25 the definition of the predicted variables are presented.

The absolute TBP point value is not used to train the PLS model, instead the distance between the point in the TBP curve and the cut point is used. The predicted variables for the PLS model are defined as follows:

T_{90L(model)}=T_{90L}−T_{CP}

T_{95L(model)}=T_{95L}−T_{CP}

T_{100L(model)}=T_{100L}−T_{CP}

T_{0H(model)}=T_{CP}−T_{0H}

T_{5H(model)}=T_{CP}−T_{5H}

T_{10H(model)}=T_{CP}−T_{10H}

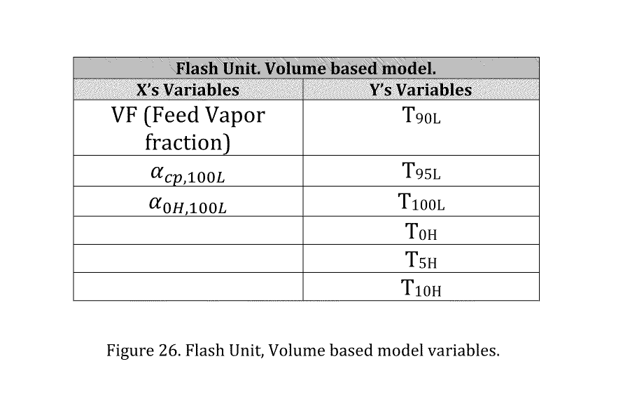

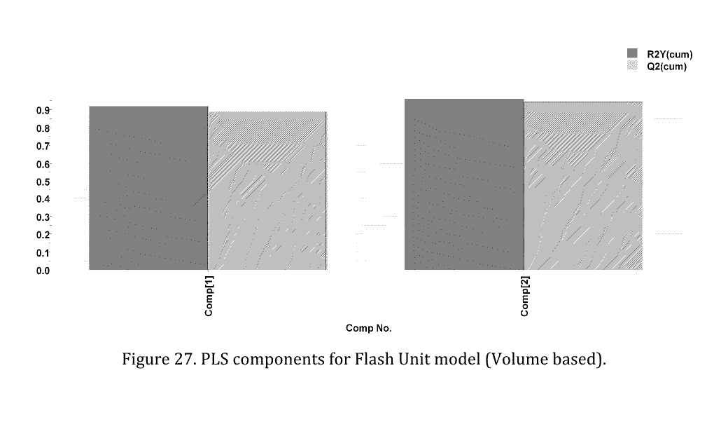

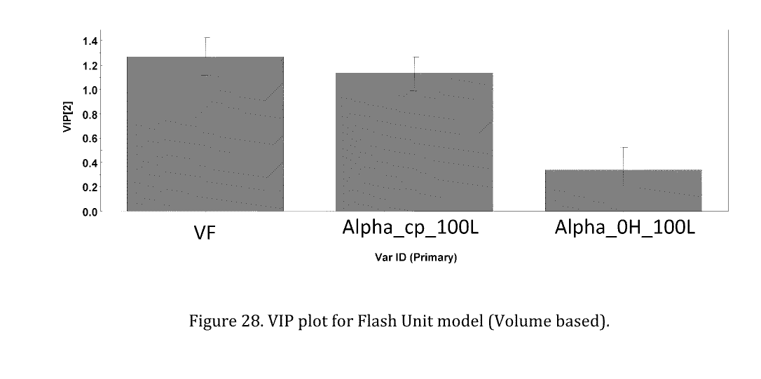

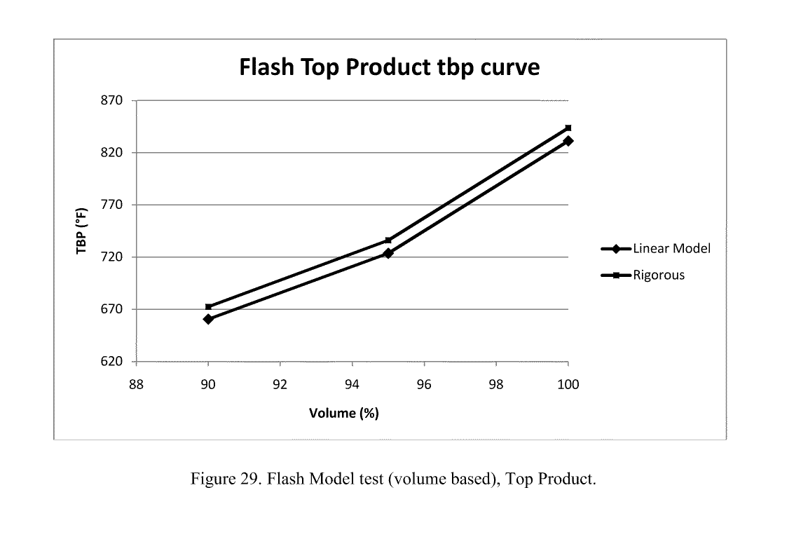

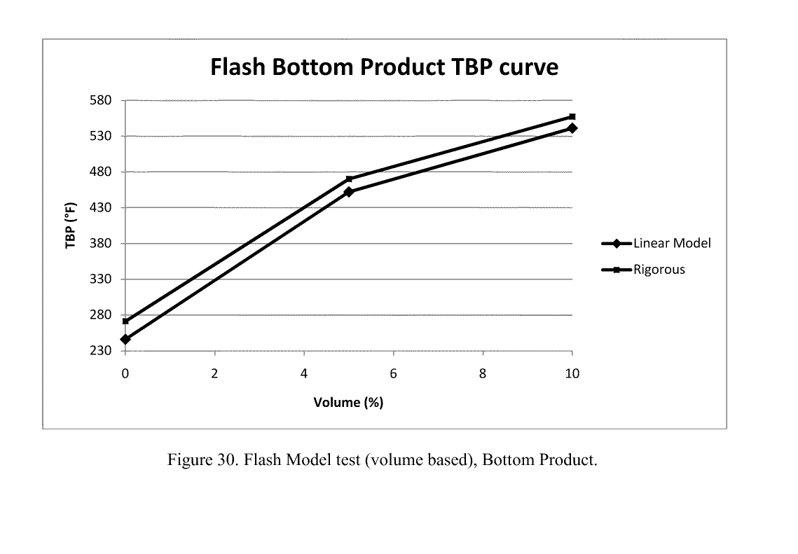

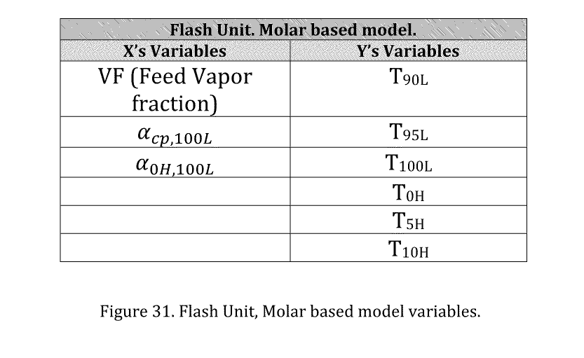

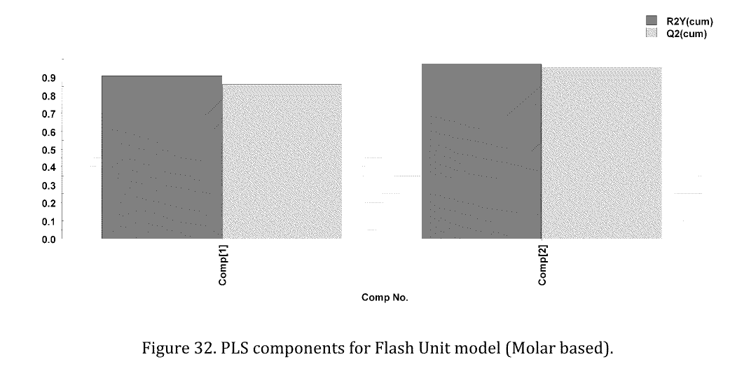

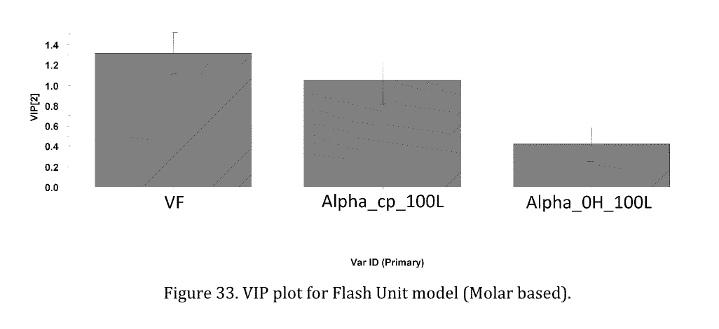

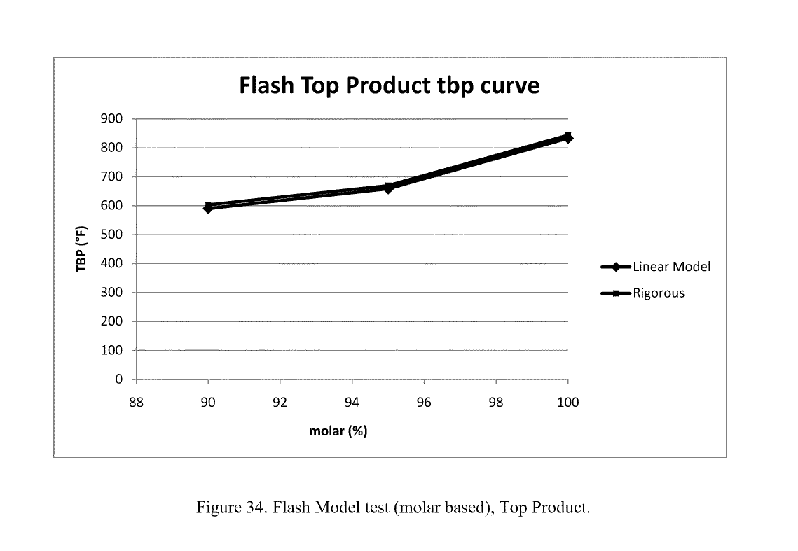

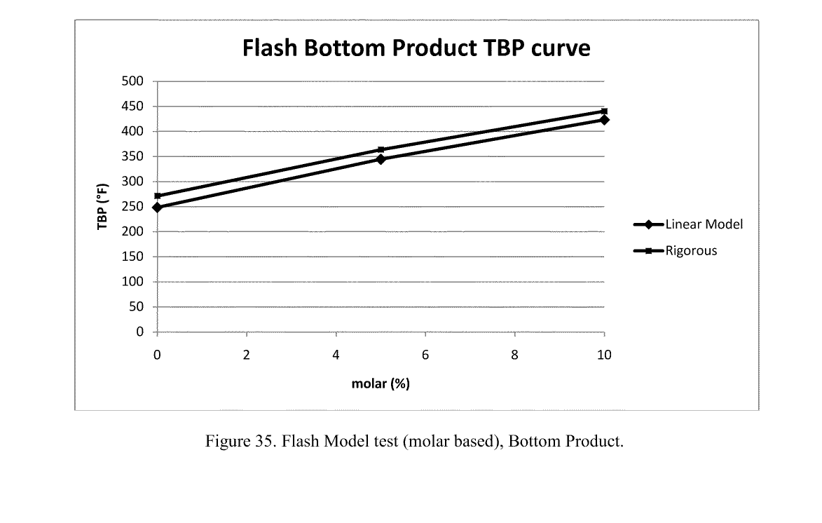

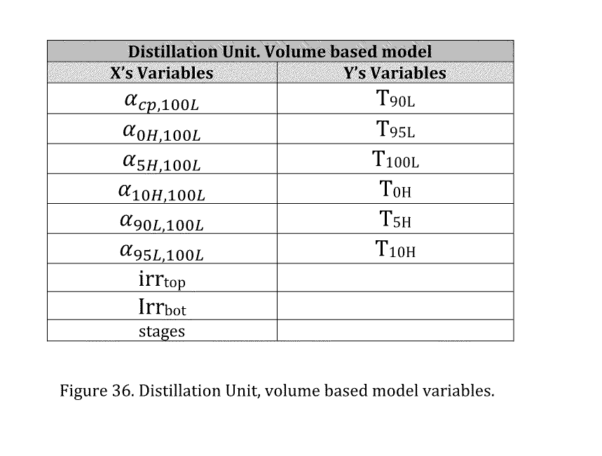

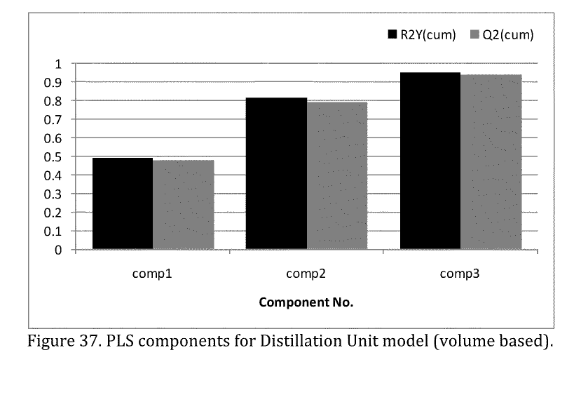

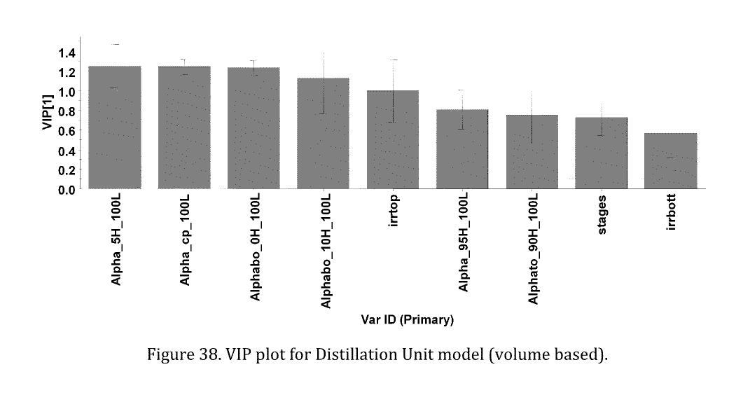

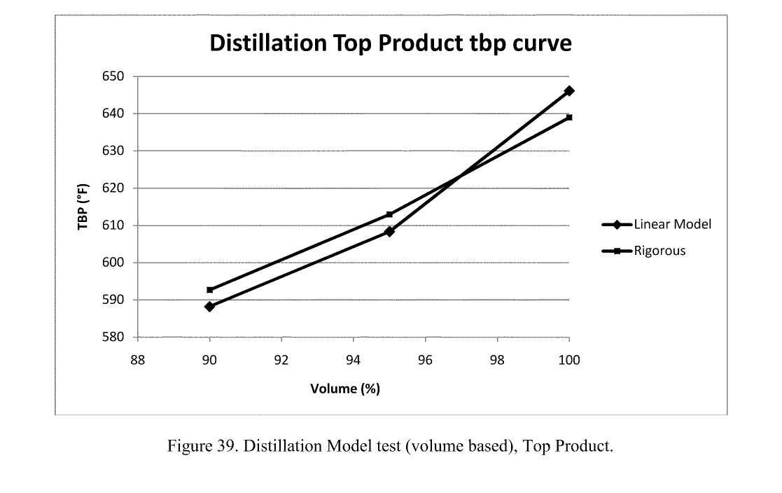

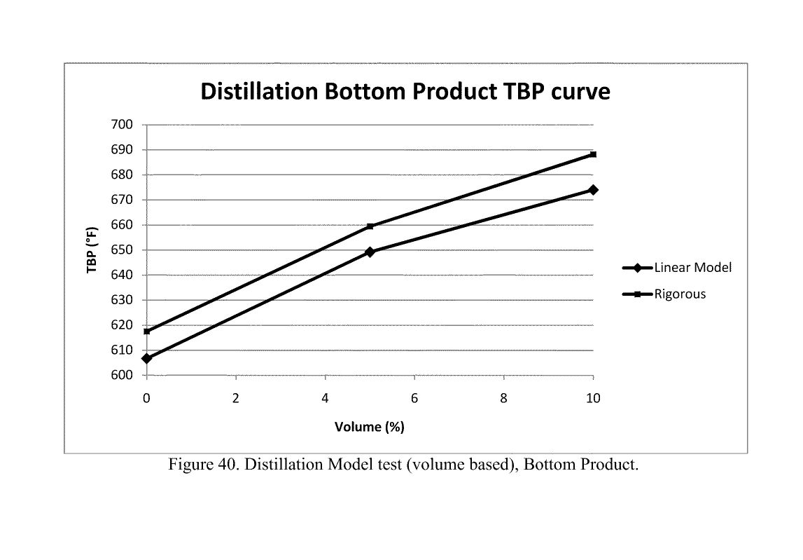

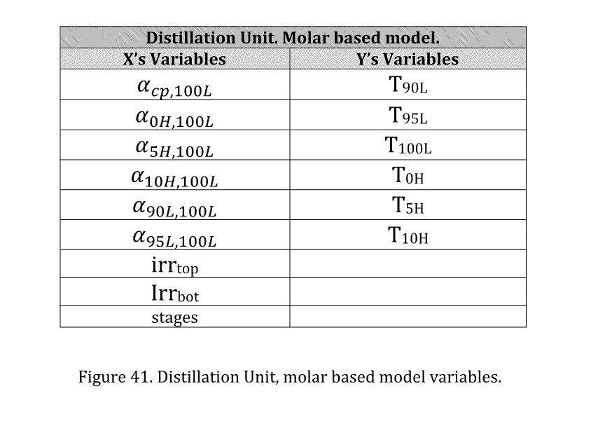

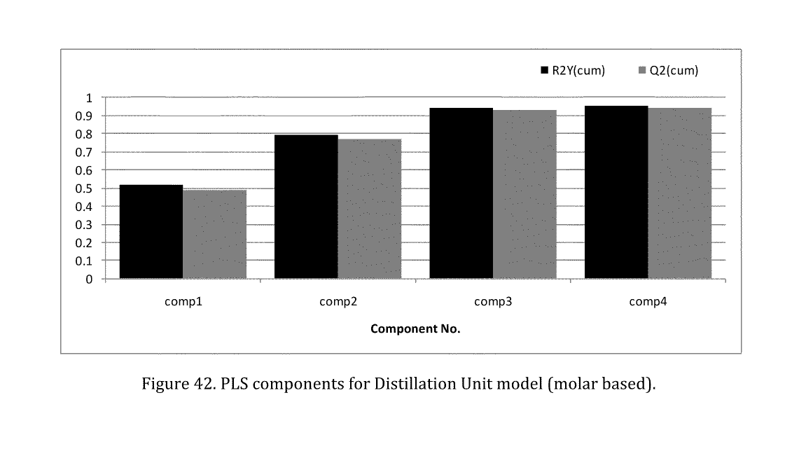

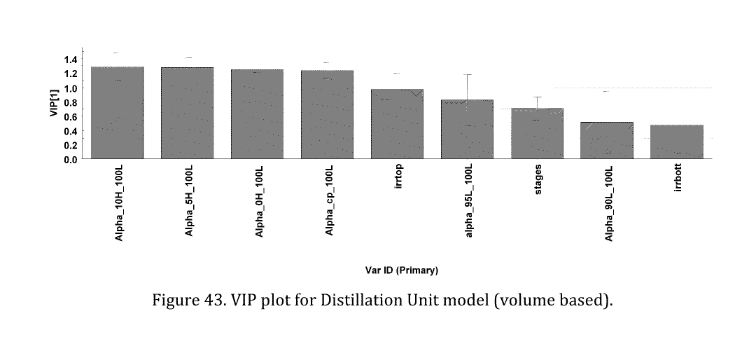

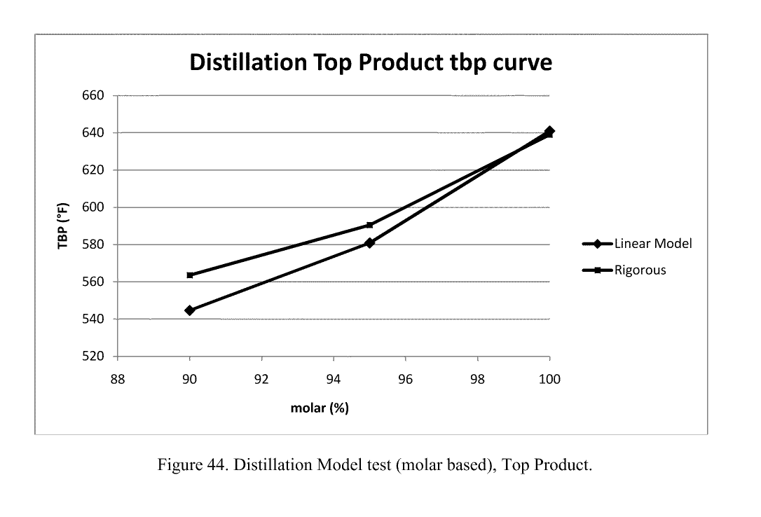

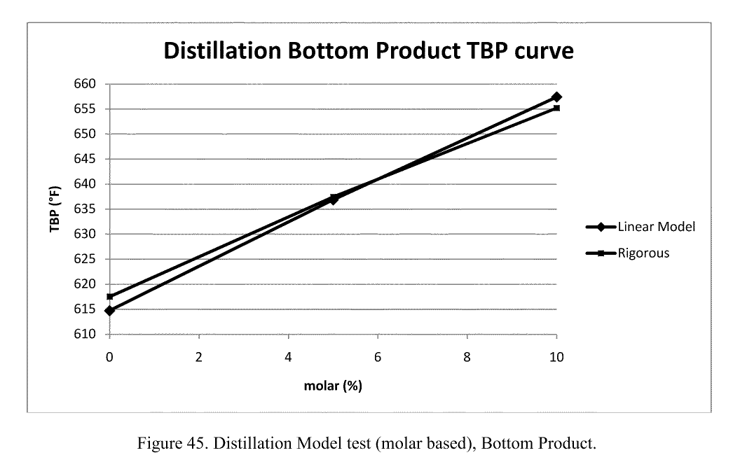

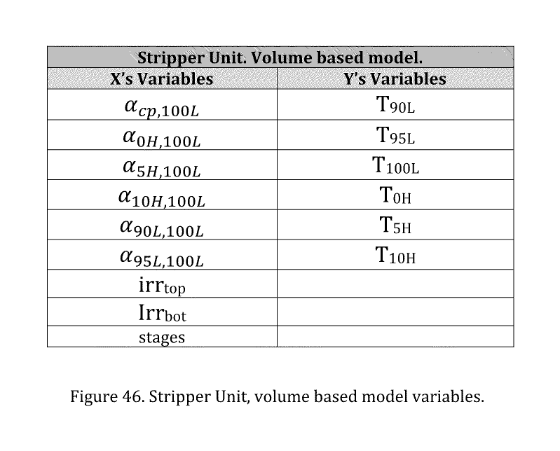

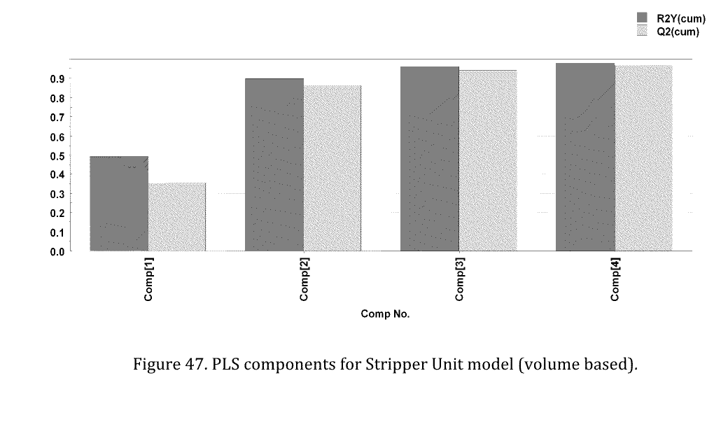

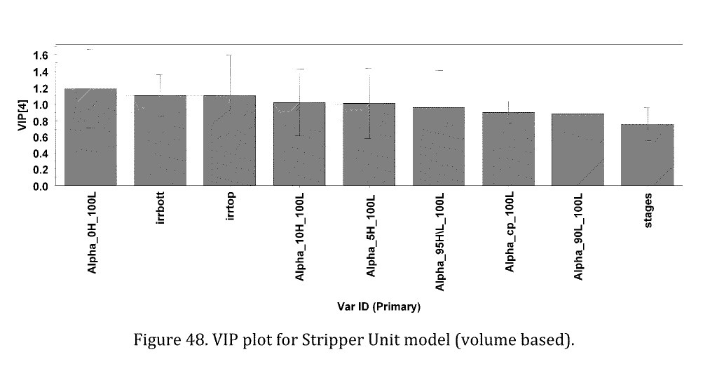

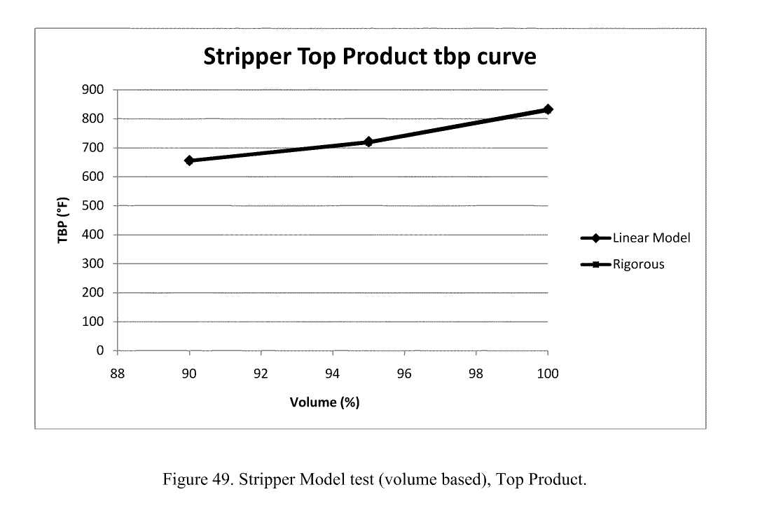

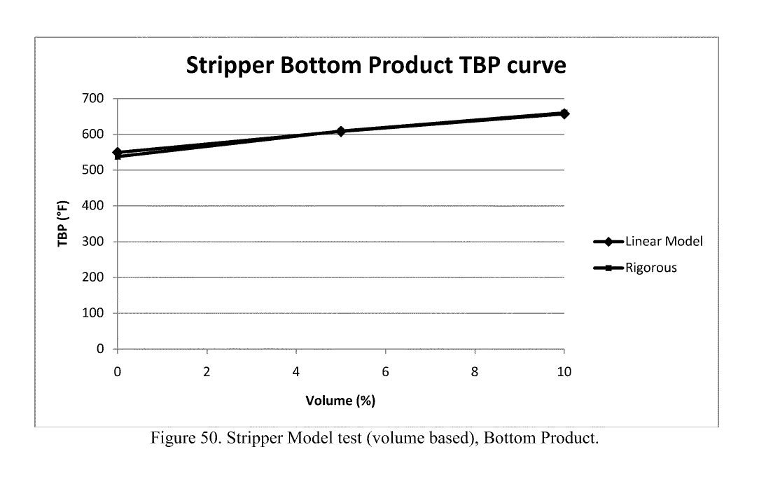

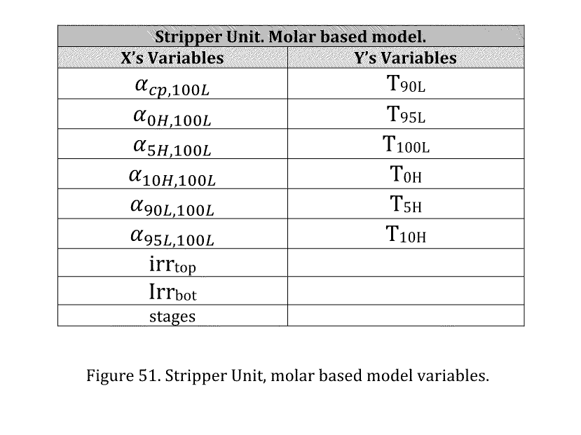

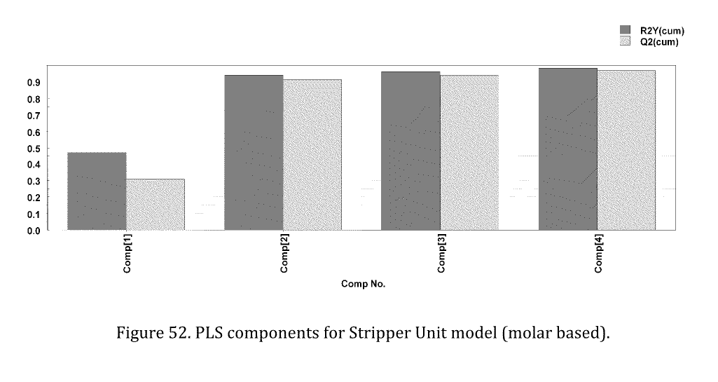

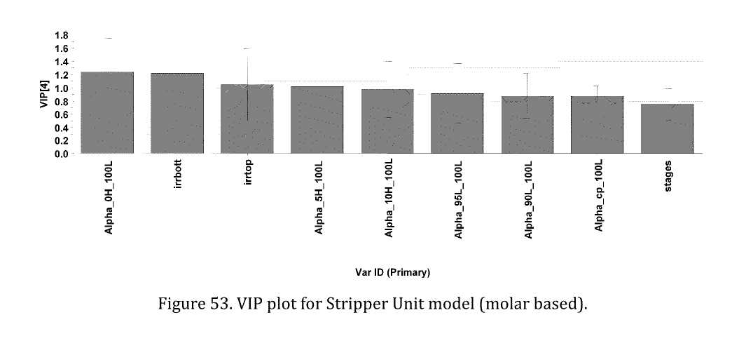

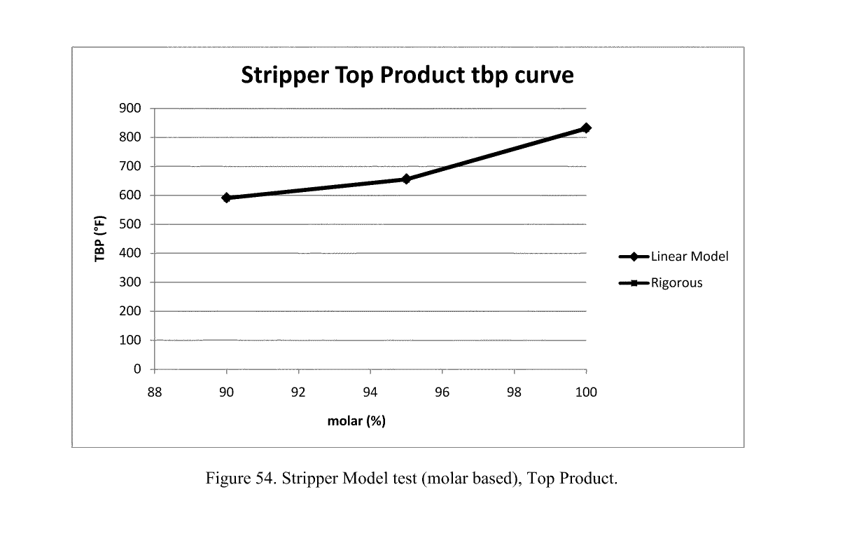

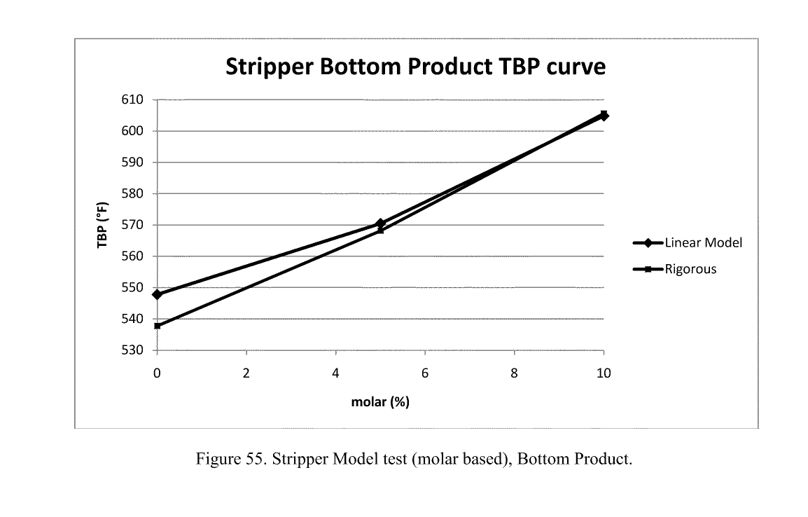

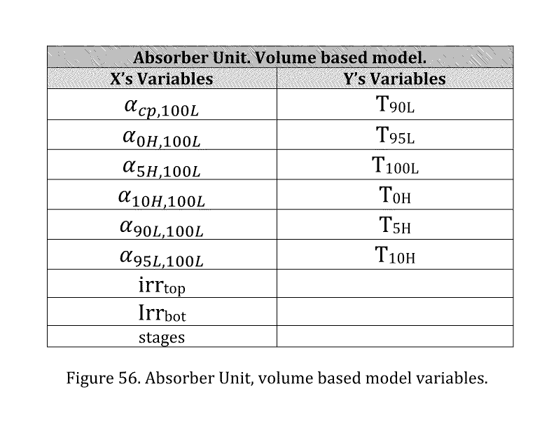

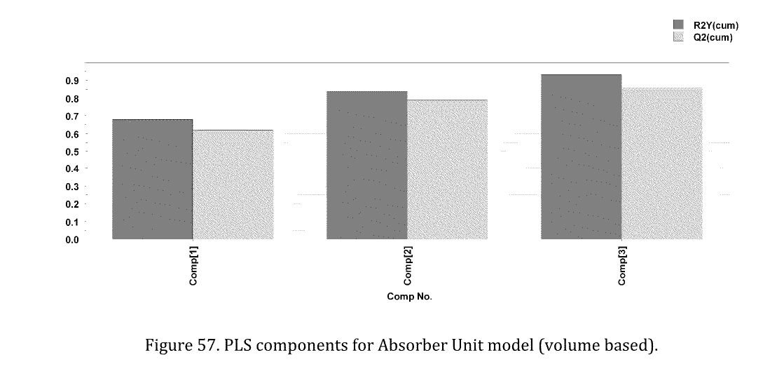

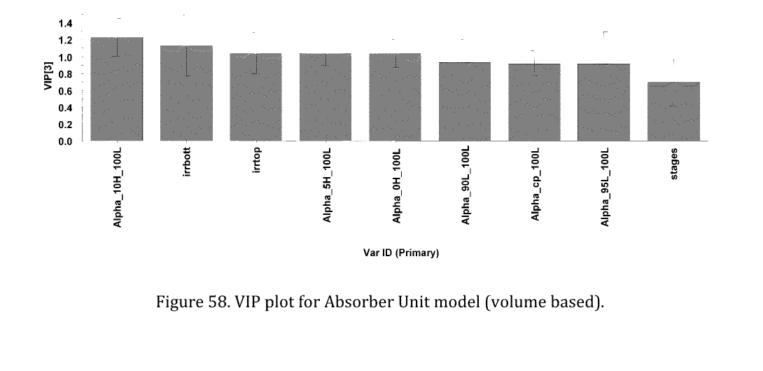

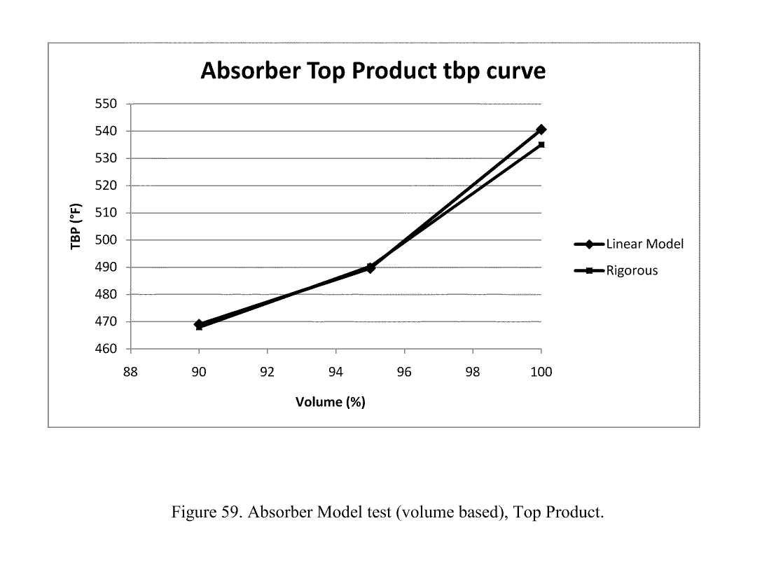

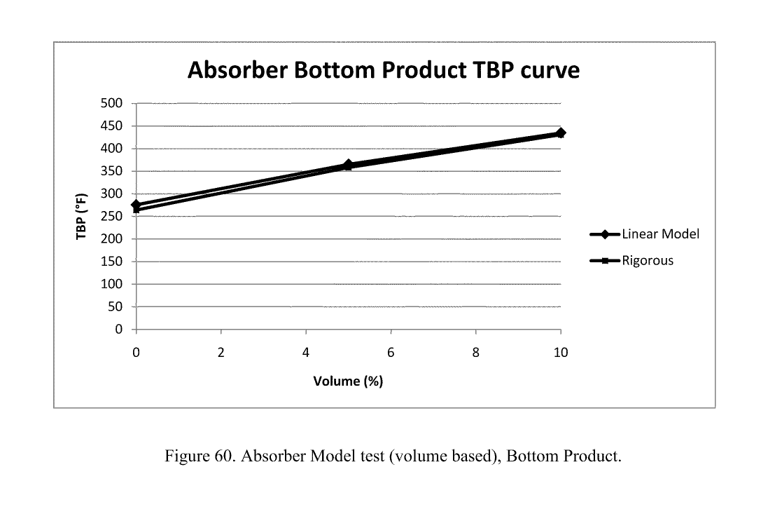

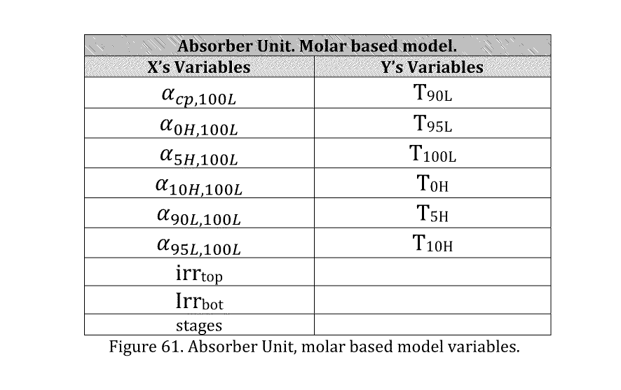

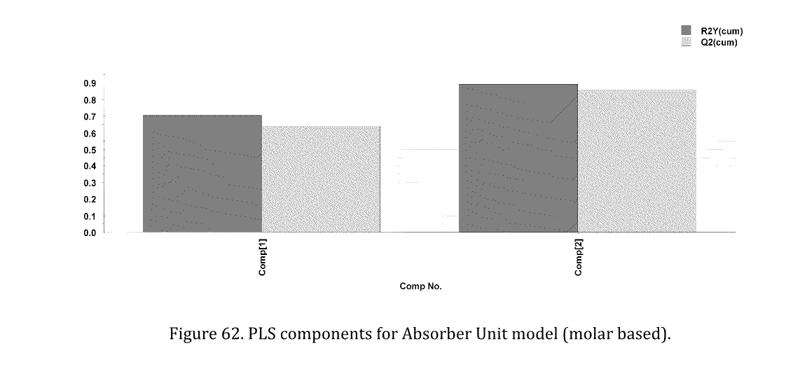

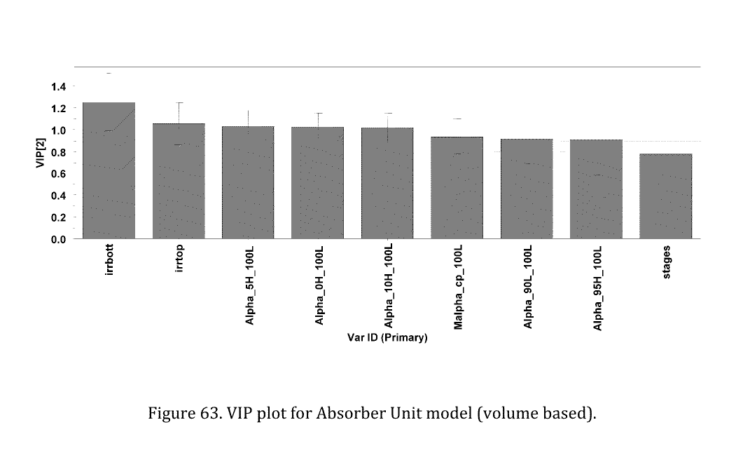

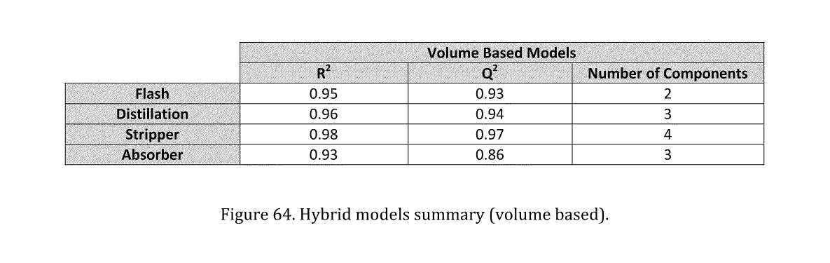

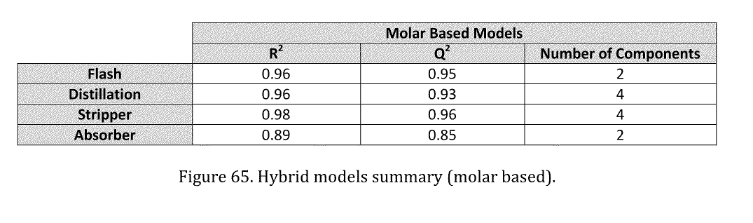

The hybrid model approach with these new modifications has been tested for several separation units included, flash, stripper, absorber and distillation. The molar representation of the TBP curves has been also studied and; the results are shown in FIG. 26-65. Prediction accuracy is about 1% to 2% with this version of the model which explicitly accounts for the effect of the number of stages in the separation equipment.

The second part of the Detailed Description will now describe hybrid models for separation of multi-component mixtures in distillation towers that have multiple pumparounds, side-strippers, and also use stripping steam. Examples of such towers are atmospheric and vacuum distillation towers in a crude unit or a main fractionator of an FCC unit in a refinery. This section describes a hybrid model for such towers.

A typical crude unit produces the following products (“fractions” of the crude oil feed) with their cutpoints temperatures being in the following ranges:
Light components (Temp<90 F)
Gasoline (90-220 F)
Naphtha (220-315 F)
Kerosene (315-450 F)
Gas Oil (450-800 F)
Residue (>800 F)

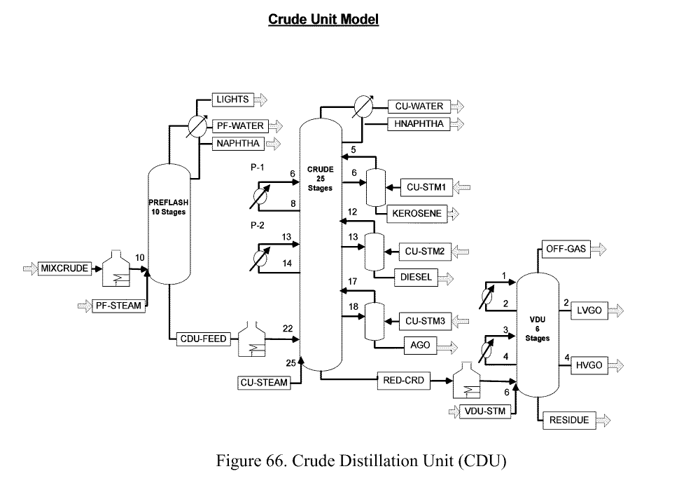

Simplified process flow diagram of a sample crude unit, consiting of a preflash column, an atmospheric pipestill and a vacuum distillation pipestill is shown in FIG. 66. The example is taken from [Aspen Technology, 2006]. Atmospheric pipestill in this sample crude unit will be used to illustrate development of the hybrid models. In the material below, stage numbers will refer to this atmospheric pipestill. Application to some other tower requires that the corresponding stage numbers and operating variables be used. This atmospheric pipestill is used as an example to illustrate the new types of hybrid models described in this invention. The models are generic and are applicable to all complex distillation towers, such as atmospheris pipestills, FCCmain fractionators, or distillation towers in petrochemcial and chemical plants.

In order to simplify model development in practice, instead of using relative volatility between components at specific points at the feed TBP curve (e.g. relative volatility between the midpoint and the end point of a product cut), we will use directly the corresponding product cut temperatures on the TBP curve of the feed. An alternative method is to use relative volatilities, as described earlier.

Four modes of hybrid model applications and the corresponding hybrid models are described here:
Mode 1: Product qualities monitoring
Mode 2: Predicting product qualities when feed properties are known
Mode 3: Predicting product qualities when feed properties are not known
Mode 4: Feed identification—estimate distillation curve of the crude oil feed to the tower.

In order to develop the hybrid model, one needs to collect data representing the operating region. In this work, data was generated by using rigorous tray to tray distillation model in AspenPlus simulator. Numerous sets of operating conditions and various mixtures of crudes as feedstock have been used to generate data that have been used to construct the partial least squares models that constitue the empirical part of the hybrid model.

Operating variables that determine performance of complex distillation towers are: feed and product flow rates, tower pressure, pumparounds heat duties, side strippers steam flow rates, and temperature of the feed at the exit of the feed preheat furnace.

In addition to the operating variables listed above, the hybrid model uses variables that represent internal operation of the tower (vapor and liquid flows, internal reflux).

The models predict the product qualities at front and back end of the product. This work uses True Boling Point distillation curves (TBP curves). These distillation curves can be converted to other types of distillation curves (e.g. ASTM D86) by using well known procedures.

Each product TBP curve will be described by the points on the curve. Data presented here illustrate hybrid models for computing various TBP temperatures, e.g. at 0%, 5%, 10%, 50%, 90%, 95%, 100% liquid volume distilled. For the overhead product, prediction of 50% and higher will be presented, since the front end of the product is equal to the front end of the feed.
Heavy Naphtha (HNAPHTHA) TBP 50%, 90%, 95%, 100%.
KEROSENE TBP 0%, 5%, 10%, 50%, 90%, 95%, 100%.
DIESEL TBP 0%, 5%, 10%, 50%, 90%, 95%, 100%.
AGO TBP 0%, 5%, 10%, 50%, 90%, 95%, 100%.

### MODE 1: Type 1 Monitoring Hybrid Model

Type 1 Monitoring Hybrid Model consists an empirical model (e.g. PLS model) that employs selected tray temperatures and feed quality (e.g. density) that indirectly relates to the feed composition to predict product quality (e.g. points on the distillation curve or % of a specific component in a given product).

A simpler version of the model can be derived by using only the selected stages temperatures correspond to the stages where there are significant changes in the liquid or vapor flows within the distillation tower, i.e.:
Stage 1, the condenser
Stage 2, the reflux return stage.
Liquid draw stages from the main tower to products side strippers (in our example, these are stages 6, 13 and 18)
Pumparound draw stages (in our example these are stages 8 and 14)
Feed stage (in our example this is stage 22)

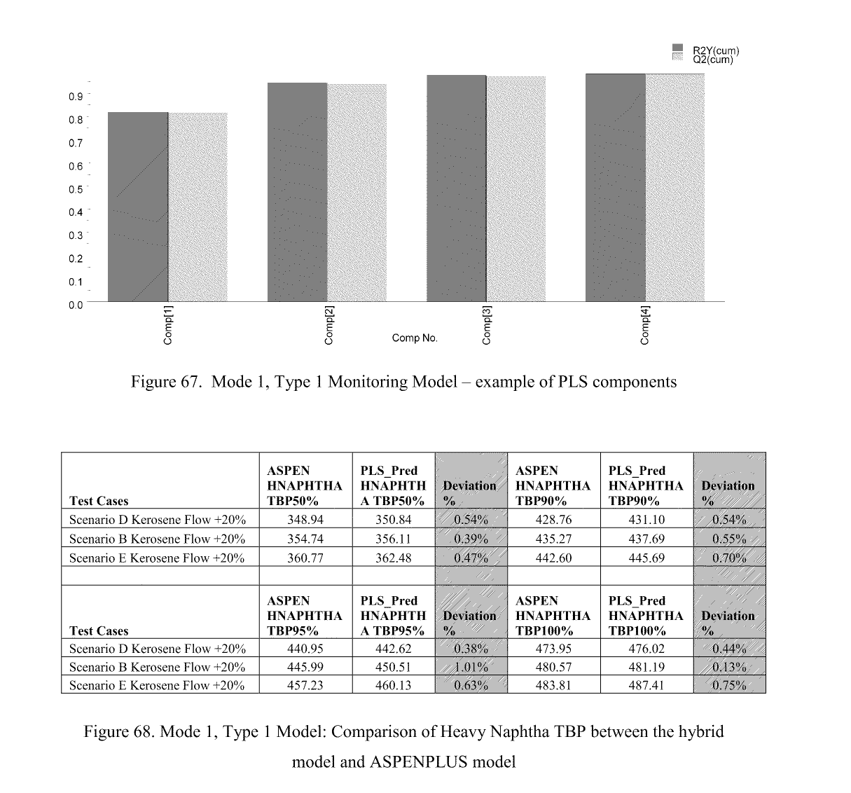

PLS model has 4 components as shown in FIG. 67. The goodness of fit is R²Y=98.4% and Q²=98.3%. Three test cases are chosen to compare ASPEN product TBP with predictions form the hybrid model. The three cases are:

### 1. Scenario D Kerosene Flow+20%

### 2. Scenario B Kerosene Flow+20%

### 3. Scenario E Kerosene Flow+20%

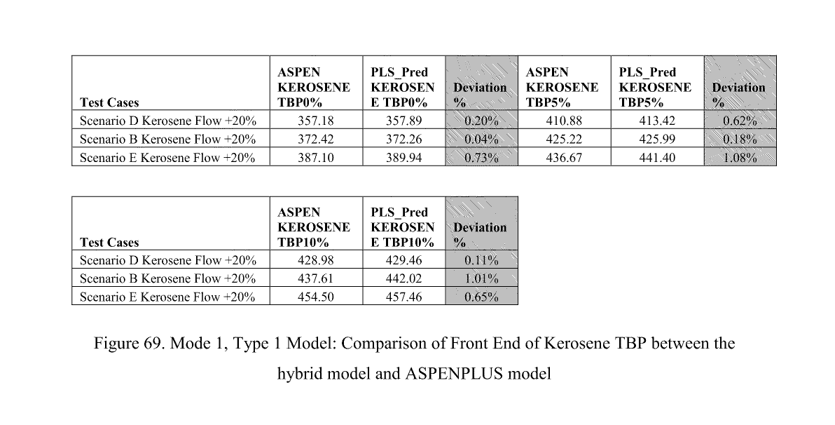

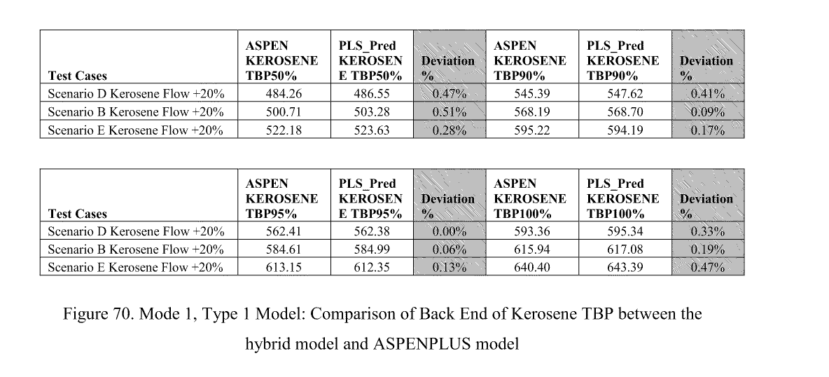

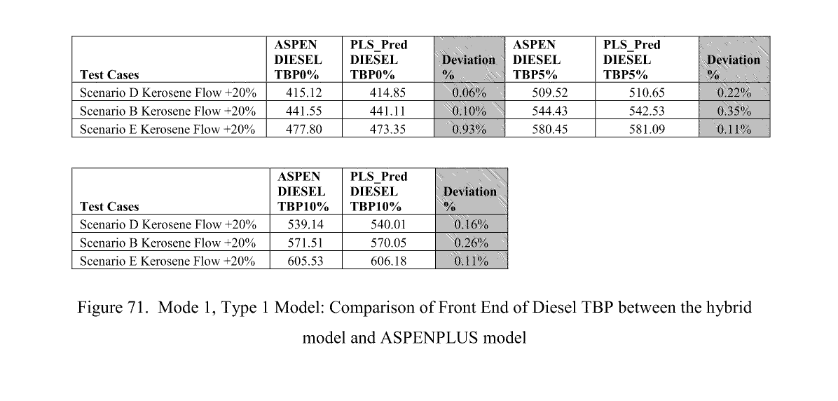

FIGS. 68-71 compare products TBP curves computed by the rigorous AspenPlus tower model to hybrid model prediction of the products TBP curves for the above scenarios and for the following product qualities:
Back end of HNaphtha
Front end of Kerosene
Back end of Kerosene
Front end of Diesel

Tables and graphs for back end of diesel, front end and back end of AGO are summarized in the figures.

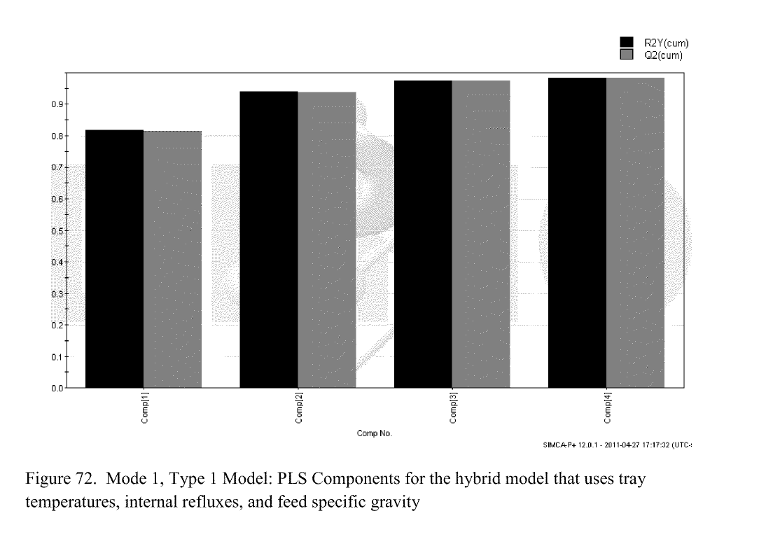

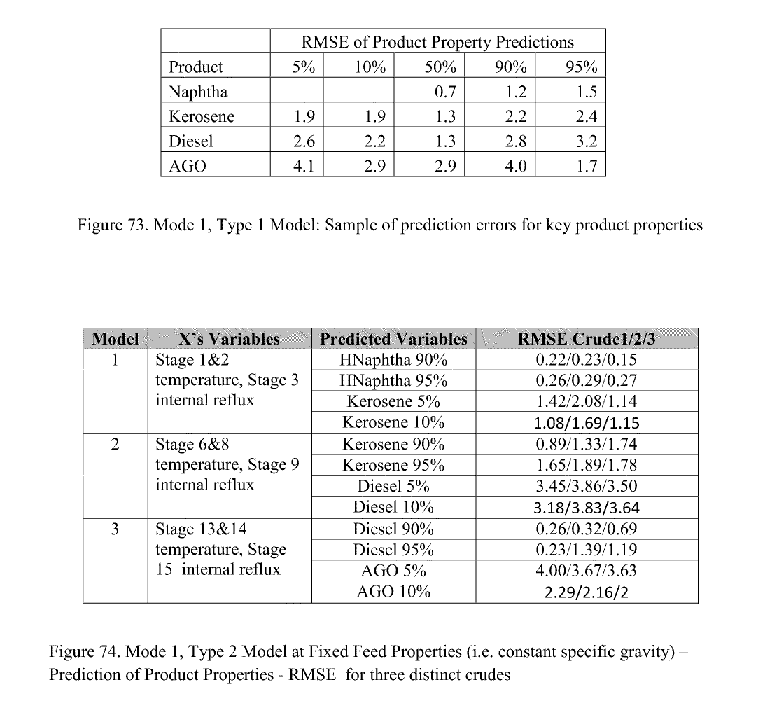

Since the range of feed mixtures can be very wide (i.e. sometimes the feed is comprised of light crude, sometimes of heavy crude or some mixture), it is recommended to use a crude bulk property that reflects the changes in the chemical nature of the feed (e.g. feed specific gravity, density) as a predictive variable, in addition to the tray temperatures. This ensures that the model will be very accurate even for the wide range of feedstocks. For a range of several different crude feedstock, the example model has a PLS model with 4 components (see FIG. 72) while the goodness of fit is R²Y=0.984 and Q²=0.983. Table in FIG. 73 provides root mean square error for prediction of the product qualities. This shows that using the crude specific gravity as an X variable enables the predictive power of the model over a wider range of crudes.

### MODE 1: Type 2 and Type 3 Monitoring Hybrid Model

Type 2 and Type 3 Monitoring Hybrid Model in this invention are used when there are not enough available tray temperature measurements to be able to develop a model of Type 1. These Monitoring Hybrid Models use operating variables to predict product properties and consists of:

1. Empirical equations that predict product properties based on the equipment internal reflux on selected trays, selected tray temperatures, feed quality (e.g. density) that indirectly relates to the feed composition, and (if applicable) additional operating variables that impact separation between products (e.g. stripping steam flows). Multi-component product properties are described either by composition or by distillation curves, which can be a True Boiling Point distillation curve or some other type of a distillation curve.
2. Mass and energy balances for the trays as required to compute the internal reflux on the trays.
3. Equations to compute liquid and vapor enthalpies at the trays.
4. Equations to compute enthalpy of all streams entering or leaving the distillation tower.

Type 2 Model predicts product TBP points directly. Model of this structure has been developed for the same example shown in previous section. One possible model structure is to use a hybrid model that employs internal reflux, tray temperatures and the specific gravity of the crude. A separate model is developed for each pairs of adjacent ends of the product distillation curves (e.g. back end of kerosene and front end of diesel). Such approach results in a PLS model that typically has between 2 and 4 components. The models with larger number of components are for those adjacent pairs where feed quality plays a role (i.e. feeds with different specific gravity have different volatility properties in the region corresponding to the adjacent pair).

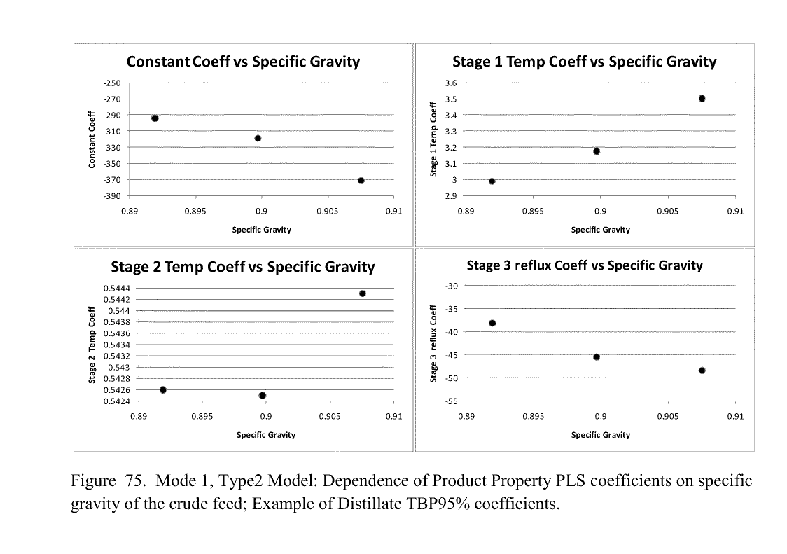

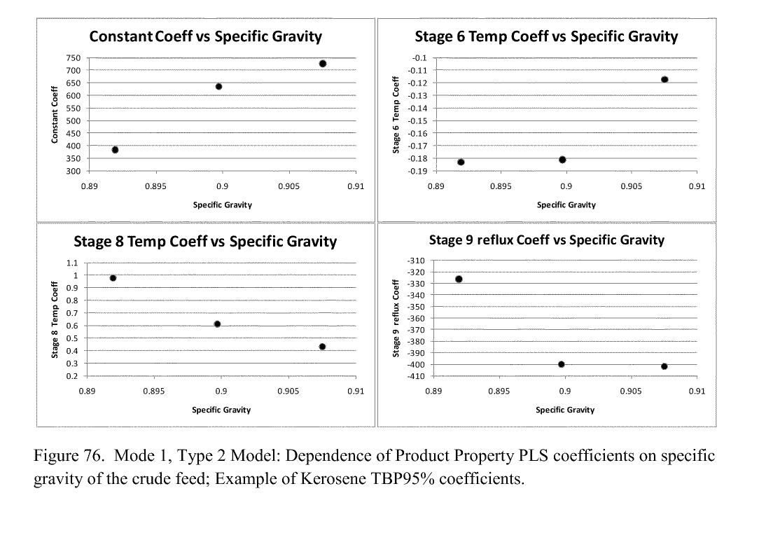

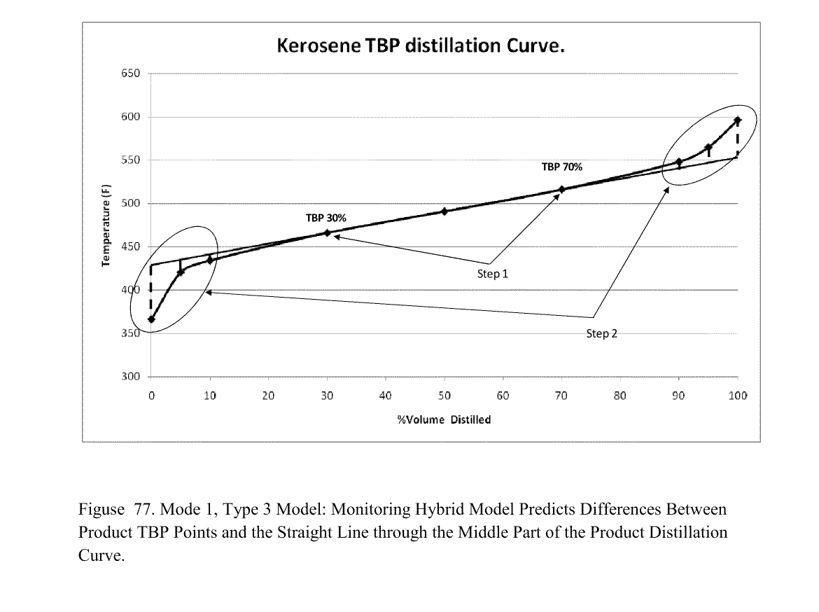

Preferred approach is to develop a separate hybrid model for each distinct crude feedstock. Each hybrid model contains a PLS model that has only 2 components and is of a very high accuracy of prediction, as summarized in FIG. 74. After this, the PLS coefficients are plotted vs. crude specific gravity. This reveals that these coefficients are dependent on the specific gravity, as illustrated in FIG. 75 and FIG. 76. Hence, the preferred empirical model (PLS) contains bilinear terms of the form [(specific gravity)*(X variable)], where specific gravity of the crude is a measured parameter.

Type 3 Model first predicts the straight line through the middle part (e.g. TBP30% and TBP70%) of the product TBP curve and the deviations of the product distillation curve from that straight line are modeled separately.

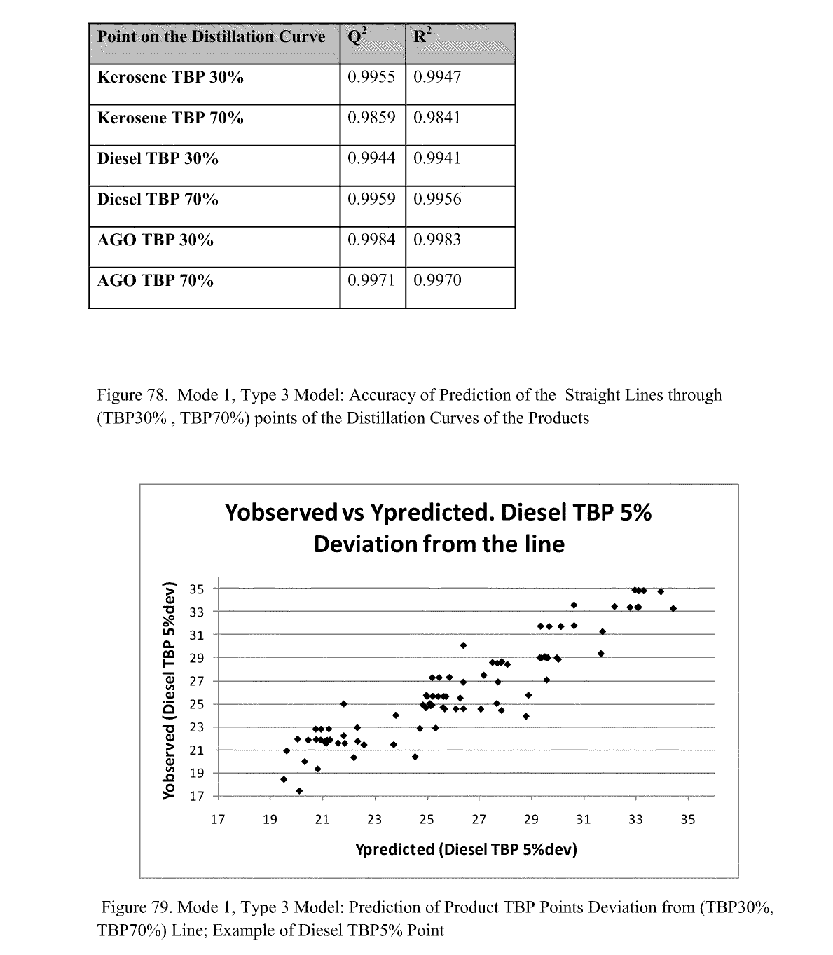

For each product, a separate model for the straight line through the middle portion is selected. Recommended X variables are: (i) internal reflux in the section above and in the section below the product draw tray, (ii) tray temperature below the draw tray of the product, (iii) the tray temperature below the draw tray of the product above, and (iv) specific gravity of the crude. Results for the sample tower are shown in FIG. 78. Following that, differences between the product TBP points (e.g. TBP90%, TBP95%) and the straight line are predicted with X variables being: internal reflux, ratio (stripping steam flow/product flow), and specific gravity of the crude. FIG. 79 illustrates the accuracy of prediction for deviations of Diesel TBP5% point from the (TBP30%, TBP70%) line.

### MODE 2: Predictive Hybrid Model “Feed Known”

Separate PLS model is developed for each product pair, i.e. distillation curve for the back end of the lighter product and the distillation curve at the front end of the heavier product. each adjacent product. This procedure results in smaller number of principal components than developing one PLS model for the entire crude pipestill.

The feed temperature at the cut point between adjacent products, the 50% cut point for each product (designated as “CP”), and internal reflux representing the typical reflux in the corresponding section of the tower are selected as X variables. The recommended choice of internal reflux is a tray below a pumparound draw, a tray below a side product draw, or a tray below the feed tray (i.e. a tray where there is a significant discontinuity in the internal flows). Presented here are the results for the sample crude distillation tower shown in FIG. 66.

Mode 2 Example: Model of Separation between Back End of HNaphtha and Front End of Kerosene

The product qualities to be predicted (Y-variables) are:
HNAPHTHA TBP 50%, 90%, 95%, 100%.
KEROSENE TBP 0%, 5%, 10%

The predictors (X variables) are:
Feed 50% CP HNAPHTHA
Feed 50% CP KEROSENE
Feed Temp at CP KEROSENE
IRR in the section between HNaptha and Kerosene (Stage 3 is under the reflux return stage)

The resulting PLS model has 2 components. The goodness of fit (R²Y) is 97.7% and goodness of prediction (Q²) is 97.5%.

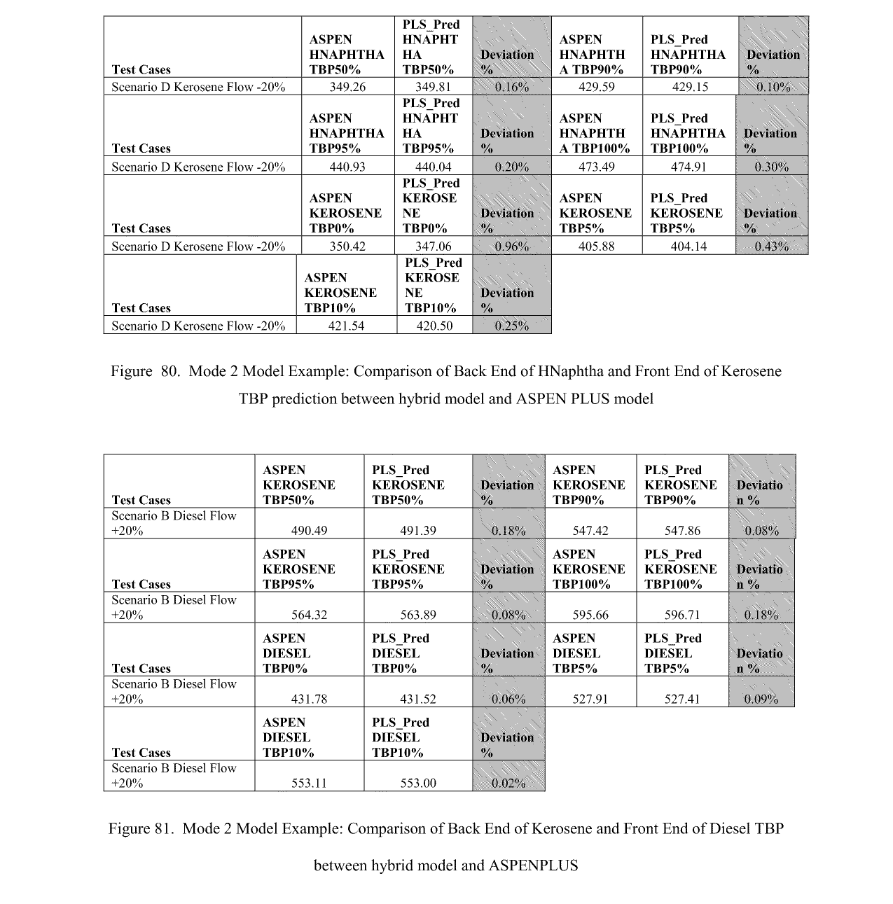

Decrease in Kerosene Flow−20% is used to show prediction of the back end of HNaphtha and front end of Kerosene. FIG. 80 summarizes the comparison between the hybrid model and AspenPlus.

Mode 2 Example: Model of Separation between the Back End of Kerosene and Front End of Diesel

The product qualities to be predicted are are:
KEROSENE TBP 50%, 90%, 95%, 100%.
DIESEL TBP 0%, 5%, 10%

The predictors (X variables) are:
Feed 50% CP KEROSENE
Feed 50% CP DIESEL
Feed Temp at CP DIESEL
Stage 9 IRR (below Pumparound draw in that section)

PLS model has 3 components. The goodness of fit (R²Y) is 98.8% and goodness of prediction (Q²) is 98.8%.

Increase in Diesel Flow+20% has been used to compare the back end of Kerosene and front end of Diesel between the hybrid model TBP predictions and ASPEN PLUS simulation results. FIG. 81 summarizes the results.

Mode 2 Example: Model of Separation between the Back End of Diesel and Front End of AGO

The predicted product properties are:
DIESEL TBP 50%, 90%, 95%, 100%.
AGO TBP 0%, 5%, 10%

The predictors (X variables) are:
Feed 50% CP DIESEL
Feed 50% CP AGO
Feed Temp at CP AGO
Stage 15 IRR (below pumparound draw in that section)

PLS model has 2 components. The goodness of fit (R²Y) is 99% and goodness of prediction (Q²) is 98.9%.

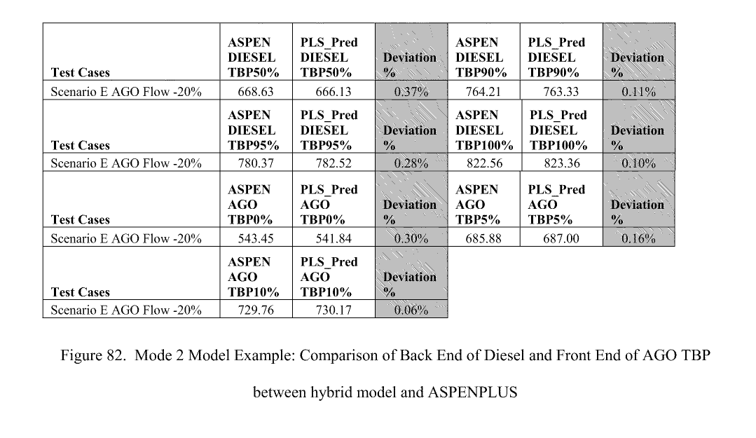

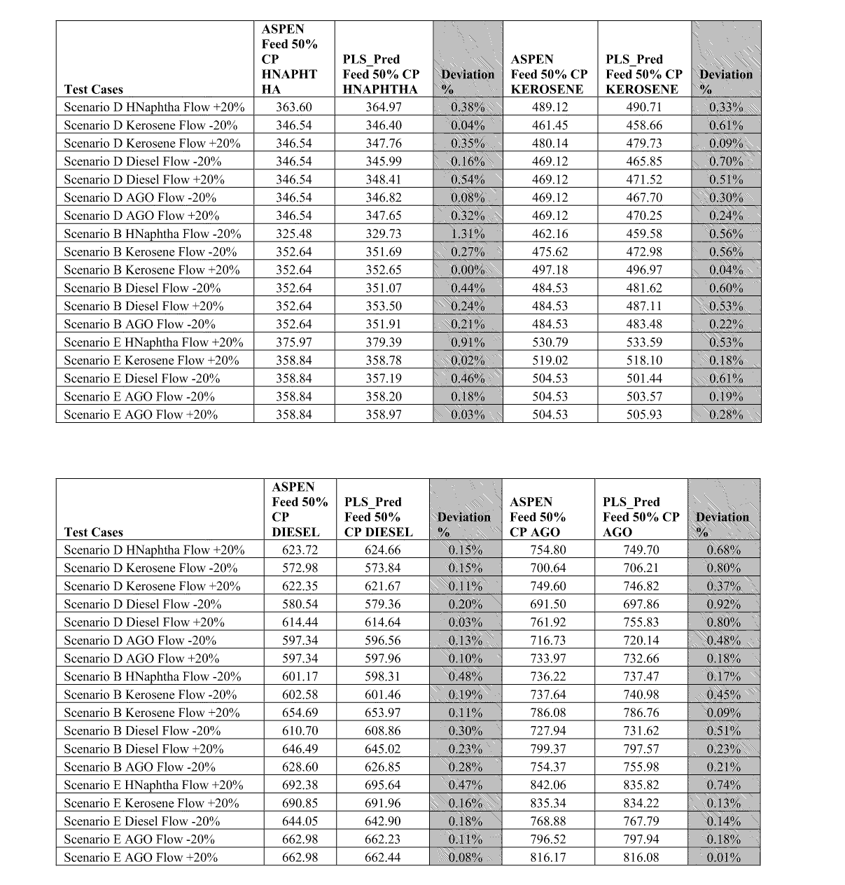

Decrease in AGO Flow−20% will be used here to illustrate the accuracy of prediction of separation between the back end of Diesel and the front end of AGO as shown in FIG. 82.

### MODE 3: Predictive Hybrid Model “Feed Unknown”

Predictive Hybrid Model “Feed Unknown” is used to predict product properties for a new set of decision variables (e.g. stream flows) when the tray temperatures are not known in advance and when feed properties are not known. This model predicts product properties by the following iterative procedure:

1. Assume tray temperatures,
2. Compute product properties from Type 2 Monitoring Hybrid Model
3. Compute tray temperatures from Type 1 Monitoring Hybrid Model
4. Check if assumed tray temperatures are the same as computed tray temperatures; if not, go to (i), otherwise stop.

This model (Mode 3 Hybrid Model “Feed Unknown”) has been applied to optimize operation of the crude distillation tower model presented in AspenPlus “Getting Started: Modeling Petroleum Processes”. The hybrid model converged to an optimum point that was 10% better than the optimum found for the tray to tray tower model by the equation oriented optimization option in AspenPlus. The results from the hybrid model were then inserted into rigorous tray to tray AspenPlus tower model and it was verified that the results of the hybrid model were in the feasible region.

### MODE 4: Identification of Feed Properties

The aim is to predict the temperatures at the feed TBP curve at mid-points of each product and at the cutpoints between the product. For the sample atmospheric tower used in this document, this corresponds to predicting the following properties:

### 1. Feed 50% CP HNAPHTHA

### 2. Feed 50% CP KEROSENE

### 3. Feed 50% CP DIESEL

### 4. Feed 50% CP AGO

### 5. Feed 50% CP KEROSENE

6. Feed Temp at CP DIESEL cut (front end)
7. Feed Temp at CP AGO cut (front end)
8. Feed Temp at CP Residual cut (front end)

Since temperature on a distillation tower tray corresponds to the composition on the stage, and it is impacted by the distribution of product draw along the tower height, the predictor variables (X variables) are temperatures on the stages that have significant change in liquid flows. For the atmospheric pipestill from AspenTech Manual (2006) these are:
Stage 2 temperature (reflux stage)
Stages 6, 13 and 18 (the liquid draw stages from the main tower to side strippers)
Stage 8 and 14 (pumparound draw stages)
Stage 22 (feed stage)

The resulting PLS model has 4 components. The goodness of fit (R²Y) is 99.2% and goodness of prediction (Q²) is 99.2%.

The list of the variables VIP values is:

| Var ID | |
|---|---|
| (Primary) | M1.VIP[4] |
| Stage2 | 1.124 |
| Temp | |
| Stage14 | 0.999 |
| Temp | |
| Stage8 | 0.985 |
| Temp | |
| Stage18 | 0.981 |
| Temp | |
| Stage13 | 0.972 |
| Temp | |
| Stage22 | 0.965 |
| Temp | |
| Stage6 | 0.964 |
| Temp | |

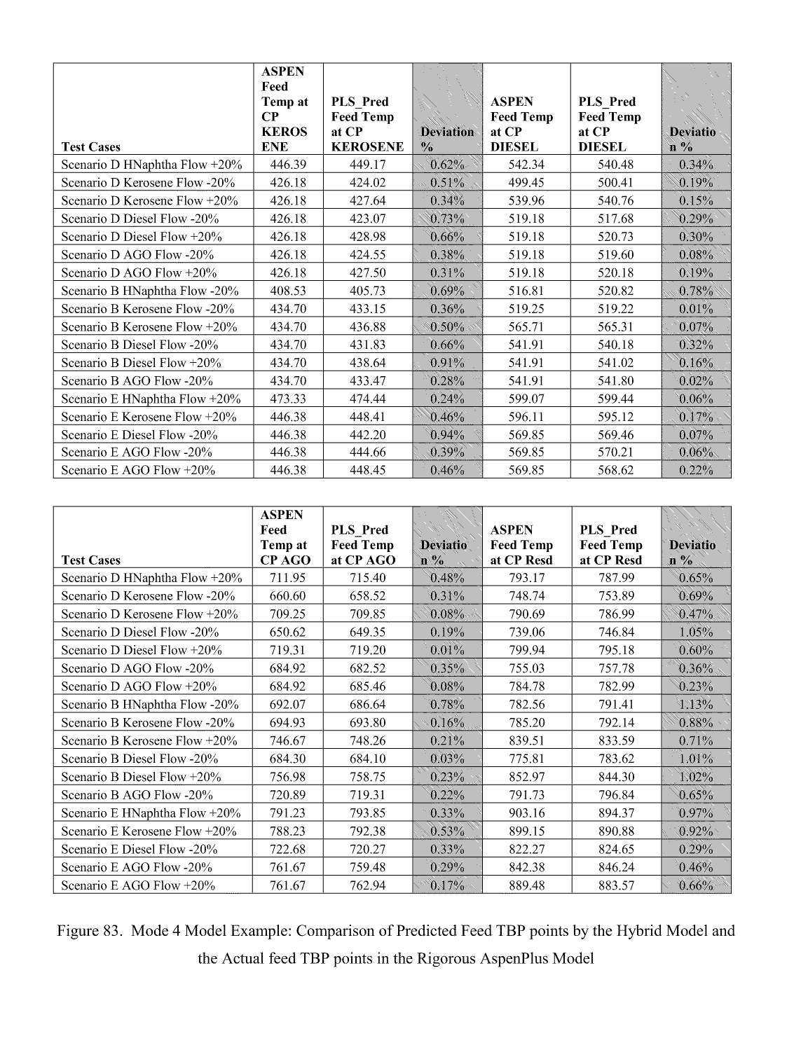

FIG. 83 compares feed properties for 18 test cases as predicted by ASPEN PLUS model and by the hybrid model.

The model provides excellent predictions of:
1. Feed 50% CP HNAPHTHA
2. Feed 50% CP KEROSENE
3. Feed 50% CP DIESEL
4. Feed 50% CP AGO
5. Feed Temp at CP KEROSENE
6. Feed Temp at CP DIESEL
7. Feed Temp at CP AGO

However, the model does not predict well the Feed TBP at CP Residual due to unavailability of the experimental data at a variety of conditions around AGO and Residual crude separation. The same accuracy is expected if more data are provided for the separation between the AGO and the residual crude.

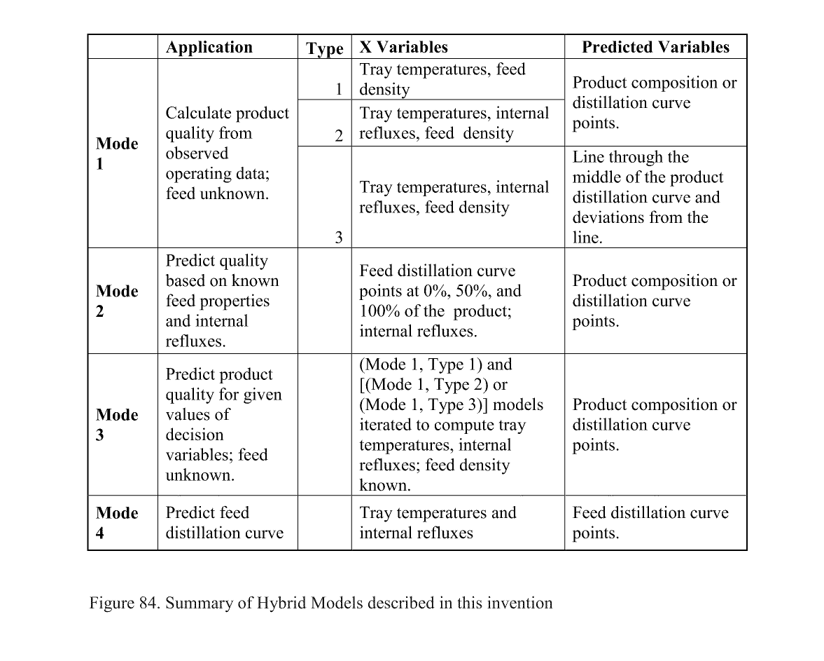

Summary of the hybrid models described in this invention is given in FIG. 84.

What is claimed is:

1. A model for predicting performance of vapor liquid separation equipment, the model comprising:
material balance equations for selected trays in said equipment;
energy balance equations for selected tray in said equipment;
an empirical model for relating operating variables, internal refluxes, volatility related properties of a feed to said equipment, and volatility related properties or composition of products of said equipment.

2. A model according to claim 1 wherein said operating variables include internal reflux ratios and at least one of:
tray temperatures;
product flows;
heat removed from the tower supplied to the tower; and
stripping stream flows.

3. A model according to claim 1 wherein feed density is used in place of said volatility related properties of said feed.

4. A model according to claim 1 wherein said feed is represented by boiling point curves.

5. A model according to claim 1 wherein said products of said equipment are represented by their boiling point curves.

6. A model according to claim 1 wherein said model further comprises equations to compute liquid and vapor enthalpies at trays of said equipment.

7. A model according to claim 1 wherein said model further comprises equations for computing enthalpy for streams entering said equipment.

8. A model according to claim 1 wherein said model further comprises equations for computing enthalpy for streams leaving said equipment.

9. A model according to claim 1 wherein said model uses feed True Boiling Point cut point temperatures to estimate the properties of products of said equipment.

10. A model according to claim 1 wherein said model predicts properties of products of said equipment using a process comprising the steps of:
(a) assume tray temperatures,
(b) compute product properties from one form of a hybrid model,
(c) compute tray temperatures from another form of a hybrid model,
(d) determine if assumed tray temperatures are the same as computed tray temperatures;
(e) in the event said assumed tray temperatures are not the same as computed tray temperatures, repeat steps (a)-(d).

11. A model according to claim 1 wherein said model predicts points on a feed distillation curve using tray temperatures from internal reflux on selected trays on said equipment.

12. Use of a model for predicting performance of vapor liquid separation equipment, the model comprising:
material balance equations for selected trays in said equipment;
energy balance equations for selected tray in said equipment;
an empirical model for relating operating variables, volatility related properties of a feed to said equipment, and volatility related properties of products of said equipment.

13. A method for predicting performance of vapor liquid separation equipment, the method comprising:
a) providing material balance equations for selected trays in said equipment;
b) providing energy balance equations for selected tray in said equipment;
c) providing an empirical model for relating operating variables, internal reflux, volatility related properties of a feed to said equipment, and volatility related properties of products of said equipment.

14. A method according to claim 13 wherein said operating variables include internal reflux ratios and at least one of:
tray temperatures;
product flows;
heat removed from the tower;
or supplied to the tower; and
stripping stream flows.

15. A method according to claim 13 wherein feed density is used in place of said volatility related properties of said feed.

16. A method according to claim 13 wherein said feed is represented by boiling point curves.

17. A method according to claim 13 wherein said products of said equipment are represented by their boiling point curves.

18. A method according to claim 13 further comprising the step of providing equations to compute liquid and vapor enthalpies at trays of said equipment.

19. A method according to claim 13 further comprising the step of providing equations for computing enthalpy for streams entering said equipment.

20. A method according to claim 13 further comprising the step of providing equations for computing enthalpy for streams leaving said equipment.
